(19) United States
(12) Patent Application Publication
(10) Pub. No.: US 2026/0276993 A1
(43) Pub. Date: Sep. 17, 2026

(54) LIGHT GUIDE DEVICE, PROJECTION DEVICE, AND ELECTRONIC DEVICE COMPRISING SAME

(71) Applicant: LG INNOTEK CO., LTD., Seoul (KR)

(72) Inventors: Joong Hoon LEE, Seoul (KR); Gwui Youn PARK, Seoul (KR); Jun Min LEE, Seoul (KR); A Rum HAN, Seoul (KR); Ho Jin PARK, Seoul (KR); Sung Ki KIM, Seoul (KR)

(21) Appl. No.: 19/166,362

(22) PCT Filed: Mar. 15, 2024
(86) PCT No.: PCT/KR2024/003287

§ 371 Date: Sep. 17, 2025

(30) Foreign Application Priority Data
Mar. 17, 2023 (KR) 10-2023-0035327
Mar. 17, 2023 (KR) 10-2023-0035328
Mar. 15, 2024 (KR) 10-2024-0036336
Mar. 15, 2024 (KR) 10-2024-0036337

(51) Int. Cl. G02B 27/01; G03B 21/20; G03B 21/28

(52) U.S. Cl. CPC G02B 27/0172; G03B 21/2066; G03B 21/208; G03B 21/28; G02B 2027/0178

(57) ABSTRACT

An embodiment provides an electronic device comprising: a projector; a light guide device which guides light emitted from the projector; and an image rotation element which is disposed between the projector and the light guide device, wherein the image rotation element rotates light, emitted from the projector, about the lengthwise direction of the image rotation element. An embodiment provides a projection device comprising: a light source unit which is disposed in a housing; a light modulator which is disposed at one surface of the housing; a lens unit which is disposed at the rear end of the light source unit; a reflection unit which is disposed between the light source unit and the light modulator; a projection lens unit; and a prism which is disposed between the light modulator and the projection lens unit, wherein the light source unit, the lens unit, and the reflection unit are successively disposed and arranged to be inclined to the top surface of the light modulator or the housing.

### CROSS-REFERENCE TO RELATED APPLICATIONS

This application is the U.S. national stage application of International Patent Application No. PCT/KR2024/003287, filed Mar. 15, 2024, which claims the benefit under 35 U.S.C. § 119 of Korean Application Nos. 10-2023-0035327, filed Mar. 17, 2023; 10-2023-0035328, filed Mar. 17, 2023; 10-2024-0036336, filed Mar. 15, 2024; and 10-2024-0036337, filed Mar. 15, 2024; the disclosures of each of which are incorporated herein by reference in their entirety.

### TECHNICAL FIELD

Embodiments relate to a light guide device, a projection device, and an electronic device including the same.

### BACKGROUND ART

Virtual reality (VR) refers to a specific environment, situation, or technology itself that resembles reality created by artificial technology using computers or the like but is not real.

Augmented reality (AR) refers to a technology that combines virtual objects or information with a real environment to make it look like objects existing in the original environment.

Mixed reality (MR) or hybrid reality refers to the merging of the virtual worlds and real worlds to create new environments or new information. In particular, it is called mixed reality when it is possible to interact in real time between what exists in reality and what exists in the virtual in real time.

At this time, the created virtual environment, situation, or the like stimulates the user's five senses and enables spatial and temporal experiences similar to those of the real world, thereby enabling users to travel freely across the boundaries between reality and imagination. In addition, users can not only immerse themselves in such environments but also interact with the elements realized in such environments, such as adding operations and providing instructions using devices existing in the real space.

Recently, research on equipment (including gears and devices) used in these technical fields has been actively conducted. However, the need for miniaturization and improvement of optical performance of the equipment is emerging.

### DISCLOSURE

### Technical Problem

Embodiments provide a projection device and an electronic device that are miniaturized and compact by adjusting the positions of a light source, a mirror, a lens, a prism, a light modulator, and a projection device when using a light guide device, a projection device, and an electronic device including the same, which are used for augmented reality (AR) and the like.

In addition, embodiments provide an electronic device capable of providing an image to a user without loss of resolution even while using an image ratio with a greater vertical length than a horizontal length for size reduction when using a light guide device and an electronic device including the same, which are used for augmented reality (AR) and the like.

In addition, embodiments may provide an electronic device that achieves overall miniaturization and provides an image ratio comfortable for a user by positioning a projection device and the like in upper and lower portions of a frame.

In addition, embodiments may provide a projection device and an electronic device in which miniaturization is easily realized by reducing a height of the projection device in a second direction while avoiding interference between components through an inclined structure formed among the components such as a light source, a lens unit, and individual lenses.

In addition, embodiments may provide a projection device and an electronic device in which color separation caused by a light source, which emits light in different wavelength bands, is minimized.

Embodiments may provide a projection device and an electronic device in which manufacturability is improved and performance is maintained, by setting inclination angles.

In addition, embodiments may provide a projection device and an electronic device with a reduced volume through adjustment of the positions of a lens unit and a prism.

Objectives to be solved by the embodiment are not limited to the above-described objectives and will include objectives and effectiveness which may be identified by solutions for the objectives and the embodiments described below.

### Technical Solution

An electronic device according to an embodiment includes a projector, a light guide device configured to guide light emitted from the projector, and an image rotating element disposed between the projector and the light guide device, wherein the image rotating element rotates the light emitted from the projector about a longitudinal direction of the image rotating element.

The image rotating element may be disposed adjacent to the projector and spaced apart from the projector by a first distance.

The image rotating element may be disposed spaced apart from the light guide device by a second distance.

A traveling direction of the light emitted from the projector may be parallel to the longitudinal direction of the image rotating element.

When an angle formed between a length and a height of the projector increases, an angle formed between a length and a height of the image rotating element may increase.

An angle formed between a height of the projector and a cross section perpendicular to a first axis may be different from an angle formed between a height of the image rotating element and the cross section perpendicular to the first axis.

When an angle formed between a height of the projector and a cross section perpendicular to a first axis is 0°, an angle formed between a height of the image rotating element and the cross section perpendicular to the first axis may be 45°.

Optical stops of the projector and the image rotating element may be located at an incoupler of the light guide device.

A width of the image rotating element may be smaller than a length thereof.

The projector, the image rotating element, and the light guide device may overlap each other in the longitudinal direction.

The electronic device may include a frame on which the projector and the image rotating element are seated.

The image rotating element may include a prism having a trapezoidal cross section parallel to the longitudinal direction and a rectangular cross section perpendicular to the longitudinal direction.

The projector may have a length and a height greater than a width.

A projection device according to an embodiment includes a housing, a light source unit disposed inside the housing, a light modulator disposed on one surface of the housing, a lens unit disposed at a rear end of the light source unit, a reflection unit disposed between the light source unit and the light modulator, a projection lens unit, and a prism disposed between the light modulator and the projection lens unit, wherein the light source unit, the lens unit, and the reflection unit are sequentially disposed and are inclined with respect to a top surface of the housing or the light modulator.

The light source unit may include a first light source and a second light source that emit light in different directions, and may include a first mirror configured to transmit light emitted from the first light source, and a second mirror configured to reflect light emitted from the second light source.

The first mirror and the second mirror may be inclined at different angles with respect to an optical axis (OA) of the first light source.

The first mirror may have an inclination angle of 39° to 45° with respect to the optical axis (OA), and the second mirror may have an inclination angle of 46.7° to 50.7°.

The first mirror may have an inclination angle of 46.7° to 50.7° with respect to the top surface of the housing or the light modulator, and the second mirror may have an inclination angle of 53.7° to 57.7° with respect to the top surface of the housing or the light modulator.

The lens unit may include a first lens unit disposed at a rear end of the first light source, and a second lens unit disposed at a rear end of the second light source, and may include a third lens and a fourth lens sequentially disposed between the reflection unit and the lens unit, and a fifth lens disposed between the reflection unit and the prism.

The fifth lens may have an inclination angle of 1.8° to 5.8° with respect to a cross section perpendicular to the top surface of the housing or the light modulator.

The reflection unit may have an inclination angle of 48° to 56° with respect to a cross section perpendicular to the top surface of the housing or the light modulator.

An incident angle of a principal ray of light, which is reflected by the reflection unit and incident on the prism, may be in a range of 3° to 4°.

The projection lens unit may be parallel to or inclined with respect to a cross section parallel to the top surface of the light modulator.

The projection lens unit may have an inclination angle of 5° to 10° with respect to a cross section parallel to the top surface of the light modulator.

The projection lens unit may include first to fifth projection lenses sequentially arranged along the optical axis (OA).

An emission-side surface of the fifth projection lens may have the largest radius of curvature among those of the first to fifth projection lenses.

The first projection lens may have the greatest thickness among the first to fifth projection lenses.

The first projection lens may have the largest effective diameter among the first to fifth projection lenses.

The second light source may emit light in a different wavelength band.

The first mirror may be disposed between the second mirror and the first light source to reflect light in a blue wavelength band, and the second mirror may be disposed between the first mirror and the second light source to reflect light in a red wavelength band.

### Advantageous Effects

Embodiments can implement a projection device and an electronic device that are miniaturized and compact by adjusting the positions of a light source, a mirror, a lens, a prism, a light modulator, and a projection device when using a light guide device, a projection device, and an electronic device including the same, which are used for augmented reality (AR) and the like.

Further, embodiments can implement an electronic device capable of providing an image to a user without loss of resolution even while using an image ratio with a greater vertical length than a horizontal length for size reduction when using a light guide device and an electronic device including the same, which are used for augmented reality (AR) and the like.

Further, embodiments can implement an electronic device that achieves overall miniaturization and provides an image ratio comfortable for a user by positioning a projection device and the like in upper and lower portions of a frame.

Further, embodiments can implement a projection device and an electronic device in which miniaturization is easily realized by reducing a height of the projection device in a second direction while avoiding interference between components through an inclined structure formed among the components such as a light source, a lens unit, and individual lenses.

Further, embodiments can implement a projection device and an electronic device in which color separation caused by a light source, which emits light in different wavelength bands, is minimized.

Embodiments can implement a projection device and an electronic device in which manufacturability is improved and performance is maintained, by setting inclination angles.

Further, embodiments can implement a projection device and an electronic device with a reduced volume through adjustment of the positions of a lens unit and a prism.

Various advantages and effects of the present invention are not limited to the above description and can be more easily understood through the description of specific exemplary embodiments of the present invention.

### DESCRIPTION OF DRAWINGS

FIG. 1 is a block diagram illustrating a configuration of an extended reality electronic device according to an embodiment of the present invention.

FIG. 2 is a perspective view of an augmented reality electronic device according to an embodiment of the present invention.

FIG. 3 is a perspective view of a projection device according to the embodiment.

FIG. 4 is another perspective view of the projection device according to the embodiment.

FIG. 5 is an exploded perspective view of the projection device according to the embodiment.

FIG. 6 is a cross-sectional view taken along line AA′ in FIG. 3.

FIGS. 7 and 8 are views of the projection device according to the embodiment with a housing removed.

FIG. 9 is a perspective view of the housing of the projection device according to the embodiment.

FIG. 10 is a view illustrating FIG. 9 with other components inserted.

FIG. 11 is a perspective view of the projection device according to the embodiment with a tape removed.

FIG. 12 is a perspective view of the projection device according to the embodiment with the tape separated.

FIG. 13A is a cross-sectional view of the projection device according to the embodiment.

FIG. 13B is another example of FIG. 13A.

FIG. 14 is an exploded perspective view of a light source unit in the projection device according to the embodiment.

FIG. 15 is a cross-sectional view of the projection device according to the embodiment.

FIG. 16 is an enlarged view of portion K1 in FIG. 15.

FIG. 17 is a perspective view of the light source unit, a first lens unit, a second lens unit, a first mirror, a second mirror, and a third lens of the projection device according to the embodiment.

FIG. 18 is a conceptual view of the first mirror and the second mirror of the projection device according to the embodiment.

FIG. 19 is an enlarged view of portion K2 in FIG. 15.

FIG. 20 is a view illustrating light in a prism according to driving states of a light modulator in the projection device according to the embodiment.

FIG. 21 is an enlarged view of portion K3 in FIG. 15.

FIG. 22 is a conceptual view of the third lens, a fourth lens, and a fifth lens in the projection device according to the embodiment.

FIG. 23 is a perspective view of an electronic device according to an embodiment.

FIG. 24 is a plan view of the electronic device according to the embodiment.

FIG. 25 is a side view of an image rotating element, a light guide device, and the projection device in the electronic device according to the embodiment.

FIG. 26 is a plan view of the image rotating element and the projection device in the electronic device according to the embodiment.

FIGS. 27A and 27B are front views of the image rotating element in the electronic device according to the embodiment.

FIG. 28 is a schematic cross-sectional view of projection light at position P1 in FIGS. 25 and 26.

FIG. 29 is a schematic cross-sectional view of the projection light at position P2 in FIGS. 25 and 26.

FIG. 30 is another schematic cross-sectional view of the projection light at position P2 in FIGS. 25 and 26.

### MODES OF THE INVENTION

Hereinafter, exemplary embodiments of the present invention will be described in detail with reference to the accompanying drawings.

However, the technical spirit of the present invention is not limited to some embodiments which will be described and may be implemented in various forms, and one or more elements in the embodiments may be selectively combined and replaced to be used within the scope of the technical spirit of the present invention.

Further, the terms used in the embodiments of the present invention (including technical and scientific terms), may be interpreted with meanings that are generally understood by those skilled in the art unless particularly defined and described, and terms which are generally used, such as terms defined in a dictionary, may be understood in consideration of their contextual meanings in the related art.

Further, the terms used in the embodiments of the present invention are provided only to describe embodiments of the present invention and not for purposes of limitation.

In the present specification, unless clearly indicated otherwise by the context, singular forms include the plural forms thereof, and in a case in which “at least one (or one or more) among A, B, and C” is described, this may include at least one combination among all combinations which can be combined with A, B, and C.

In addition, terms such as first, second, A, B, (a), (b), and the like may be used to describe components of the embodiments of the present invention.

These terms are only provided to distinguish the components from other components, and the essence, sequence, order, or the like of the components is not limited by the terms.

In addition, when a component is described as being “connected,” “coupled,” or “linked” to another component, the component may not only be directly connected, coupled, or linked to the other component but may also be connected, coupled, or linked to the other element by still another component between the component and the other component.

Further, when a component is described as being formed “on (above)” or “under (below)” another component, the term “on (above)” or “under (below)” includes both of a case in which the two components are in direct contact with each other and a case in which one or more components are (indirectly) disposed between the two components. In addition, when a component is described as being disposed “on or under” another component, such a description may include a case in which the component is disposed at an upper side or a lower side with respect to another component.

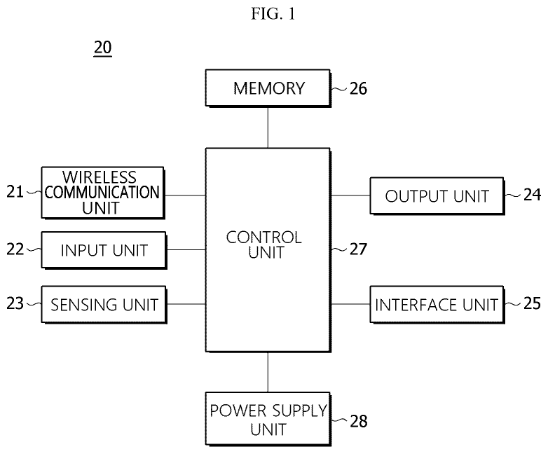

FIG. 1 is a block diagram illustrating a configuration of an extended reality electronic device according to an embodiment of the present invention.

Referring to FIG. 1, an extended reality electronic device 20 may include a wireless communication unit 21, an input unit 22, a sensing unit 23, an output unit 24, an interface unit 25, a memory 26, a control unit 27, a power supply unit 28, and the like. It is understood that implementing all the components illustrated in FIG. 1 is not a requirement for the electronic device 20, and that the electronic device 20 described in the present specification may be alternatively implemented by more or fewer components.

More specifically, among the above components, the wireless communication unit 21 may include one or more modules that allow wireless communication between the electronic device 20 and a wireless communication system, between the electronic device 20 and another electronic device, or between the electronic device 20 and an external server. Further, the wireless communication unit 21 may include one or more modules that connect the electronic device 20 to one or more networks.

The wireless communication unit 21 may include at least one of a broadcast receiving module, a mobile communication module, a wireless Internet module, a short-range communication module, and a position information module.

The input unit 22 may include a camera or an image input unit for receiving image signals, a microphone or an audio input unit for receiving audio signals, or a user input unit (for example, touch keys, push keys (mechanical keys), or the like) for receiving information from the user. Audio data or image data collected from the input unit 22 may be analyzed and processed by user control commands.

The sensing unit 23 may include one or more sensors for sensing at least one of internal information of the electronic device 20, information about a surrounding environment of the electronic device 20, and user information.

For example, the sensing unit 23 may include at least one of a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., a capturing device), a microphone, a battery gauge, an environmental sensor (e.g., a barometer, a hygrometer, a thermometer, a radiation detection sensor, a thermal sensor, a gas sensor, or the like), and a chemical sensor (e.g., an electronic nose, a health care sensor, a biometric sensor, or the like). Meanwhile, the electronic device 20 described in the present specification may utilize a combination of information sensed from at least two or more of these sensors.

The output unit 24 may be configured to output various types of information related to vision, hearing, or tactile sensations, and may include at least one of a display unit, an audio output unit, a haptic module, or an optical output unit. The display unit may have an inter-layered structure or an integrated structure with a touch sensor to implement a touch screen. The touch screen may provide an output interface between the augmented reality electronic device 20 and the user, as well as function as a user input unit that provides an input interface between the augmented reality electronic device 20 and the user.

The interface unit 25 serves as an interface with various types of external devices that are connected to the electronic device 20. Through the interface unit 25, the electronic device 20 may receive virtual reality or augmented reality content from an external device, and perform mutual interaction by exchanging various input signals, sensing signals, and data.

For example, the interface unit 25 may include at least one of wired/wireless headset ports, external charger ports, wired/wireless data ports, memory card ports, ports for connecting a device having an identification module, audio input/output (I/O) ports, video input/output (I/O) ports, and earphone ports.

Further, the memory 26 stores data supporting various functions of the electronic device 20. The memory 26 may store a plurality of application programs or applications executed in the electronic device 20, and data or instructions for operations of the electronic device 20. At least some of these application programs may be downloaded from an external server via wireless communication. Further, at least some of these application programs may be present on the electronic device 20 at the time of shipment for basic functions (e.g., receiving a call, placing a call, receiving a message, and sending a message) of the electronic device 20.

The control unit 27 typically controls overall operations of the electronic device 20 in addition to the operations related to the application programs. The control unit 27 may process signals, data, information, and the like, which are input or output by the components described above.

In addition, the control unit 27 may execute an application stored in the memory 26 to control at least some of the components and provide appropriate information to the user or process functions. Furthermore, the control unit 27 may operate by combining at least two or more of components included in the electronic device 20 to execute the application program.

In addition, the control unit 27 may detect the movement of the electronic device 20 or the user using a gyroscope sensor, a gravity sensor, a motion sensor, and the like included in the sensing unit 23. Alternatively, the control unit 27 may detect objects approaching the electronic device 20 or the user using sensors such as a proximity sensor, a light sensor, a magnetic sensor, an infrared sensor, an ultrasonic sensor, or an optical sensor included in the sensing unit 23. In addition, the control unit 27 may also detect the movement of the user through sensors provided in a controller that operates in conjunction with the electronic device 20.

Further, the control unit 27 may perform operations (or functions) of the electronic device 20 using the application programs stored in the memory 26.

The power supply unit 28 receives external power and internal power and supplies the power to the respective components included in the electronic device 20 under the control of the control unit 27. The power supply unit 28 includes a battery, which may be provided in a built-in or replaceable form.

At least some of the respective components may operate in cooperation with one another to implement the operation, control, or control method of the electronic device according to various embodiments described below. Further, the operation, control, or control method of the electronic device may be implemented on the electronic device by execution of at least one application program stored in the memory 26.

Hereinafter, the electronic device described as an example of the present invention will be described based on an embodiment applied to head mounted displays (HMDs). However, the embodiments of the electronic device according to the present invention may also include devices such as mobile phones, smart phones, laptop computers, terminals for digital broadcasting, personal digital assistants (PDAs), portable multimedia players (PMPs), navigation systems, slate personal computers (PCs), tablet PCs, ultra books, and wearable devices. The wearable devices may include watch-type terminals (smartwatches), contact lenses, VR/AR/MR glasses, and the like in addition to the HMDs.

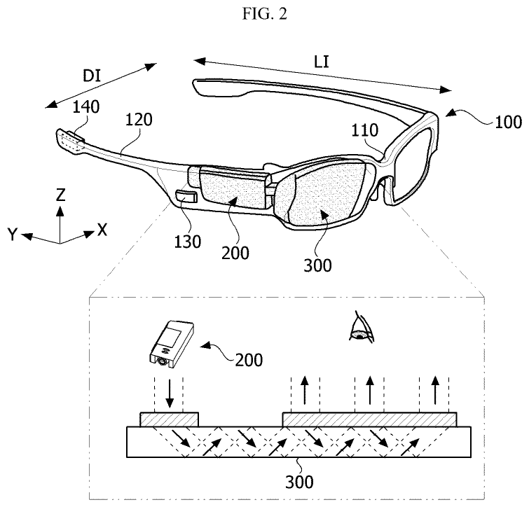

FIG. 2 is a perspective view of an augmented reality electronic device according to an embodiment of the present invention.

As shown in FIG. 2, the electronic device according to the embodiment of the present invention may include a frame 100, a projection device 200, and a display unit 300.

Furthermore, the electronic device may further include an image rotation element (hereinafter referred to as “IRE”). A detailed description thereof will be provided below.

The electronic device may be provided as a glass type (smart glass). The glass-type electronic device may be configured to be worn on the head of the human body and may include the frame (a case, a housing, or the like) 100 therefor. The frame 100 may be formed of a flexible material to facilitate wearing.

The frame 100 is supported on the head and has a space in which various components are mounted. As illustrated in the drawing, electronic components such as the projection device 200, a user input unit 130, or an audio output unit 140 may be mounted on the frame 100. In addition, a lens covering at least one of a left eye and a right eye may be detachably mounted on the frame 100.

As illustrated in the drawing, the frame 100 may have the form of glasses worn on the face of the body of a user, but the present invention is not necessarily limited thereto, and the frame 100 may have the form such as goggles or the like, which are worn in close contact with the face of the user.

The frame 100 may include a front frame 110 having at least one opening and a pair of side frames 120 that extend in a y-direction (based on FIG. 2) intersecting the front frame 110 and are parallel to each other.

The frame 100 may have a length DI in the x-direction and a length LI in the y-direction, which may be the same as or different from each other.

The projection device 200 is provided to control various electronic components provided in the electronic device. The projection device 200 may be used interchangeably with a “light output device,” a “light projection device,” a “light irradiation device,” an “optical device,” a “projector,” and the like.

The projection device 200 may generate an image to be shown to the user or a video of continuous images. The projection device 200 may include an image source panel that generates an image and a plurality of lenses that diffuse and converge light generated from the image source panel.

The projection device 200 may be fixed to any one side frame 120 of two side frames 120. For example, the projection device 200 may be fixed to the inside or outside of any one side frame 120 or embedded and integrally formed in any one side frame 120. Alternatively, the projection device 200 may be fixed to the front frame 110 or provided separately from the electronic device.

The display unit 300 may be implemented in the form of an HMD. The HMD form refers to a display scheme that is mounted on the head and displays a video directly in front of the user's eyes. When the user wears the electronic device, the display unit 300 may be disposed to correspond to at least one of the left eye and the right eye to provide the video directly in front of the user's eye. In this drawing, it is illustrated that the display unit 300 is located at a part corresponding to the right eye to output the video toward the right eye of the user. However, as described above, the display unit 300 is not thereto and may be disposed in front of both the left and right eyes.

The display unit 300 may allow the image generated by the projection device 200 to be displayed to the user while the user visually recognizes an external environment. For example, the display unit 300 may project the image to a display area using a prism.

In addition, the display unit 300 may be formed to be light-transmitting so that the projected image and a general field of view (a range visible to the user through their eyes) may be seen at the same time. For example, the display unit 300 may be semi-transparent and may be formed of an optical element including glass. For example, the display unit 300 may be a light guide device or may include a light guide device.

In addition, the display unit 300 may be inserted into and fixed to the opening included in the front frame 110 or located on a rear surface (i.e., between the opening and the user) of the opening to be fixed to the front frame 110. In the drawing, a case in which the display unit 300 is located on the rear surface of the opening and fixed to the front frame 110 is illustrated as an example, but unlike this, the display unit 300 may be disposed and fixed at various positions of the frame 100.

As shown in FIG. 2, in the electronic device, when image light (or light emitted) for an image from the projection device 200 is incident on one side of the display unit 300, the light (or light emitted) for the image is emitted to the other side through the display unit 300 to show the image generated by the projection device 200 to the user.

As a result, the user may view the image generated by the projection device 200 while simultaneously viewing the external environment through the opening of the frame 100. That is, the video output through the display unit 300 may appear to overlap the general field of view. The electronic device may provide augmented reality (AR) in which a virtual image is overlaid on an image or background of reality using these display characteristics to show one image.

Furthermore, in addition to the above operation, the external environment and the image generated by the projection device 200 may be provided to the user with a time difference within a short period of time that is not perceivable by humans. For example, within one frame, the external environment may be provided to the user during one section, and the video from the projection device 200 may be provided to the user during another section.

Alternatively, both overlap and time difference may be provided.

In addition, the projection device according to the embodiment may have a structure described below, or may be configured to further include a waveguide and/or a glass on the described structure. In addition, the projection device may include a digital light processing (DLP) projector or projection device.

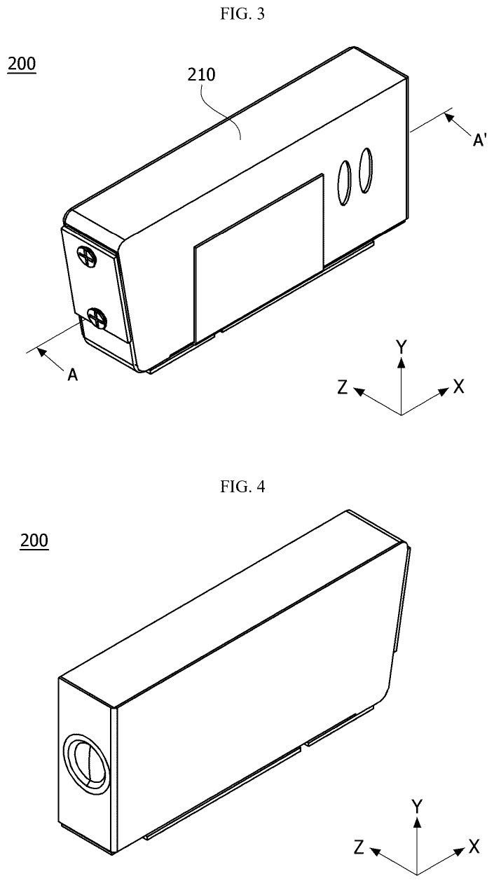

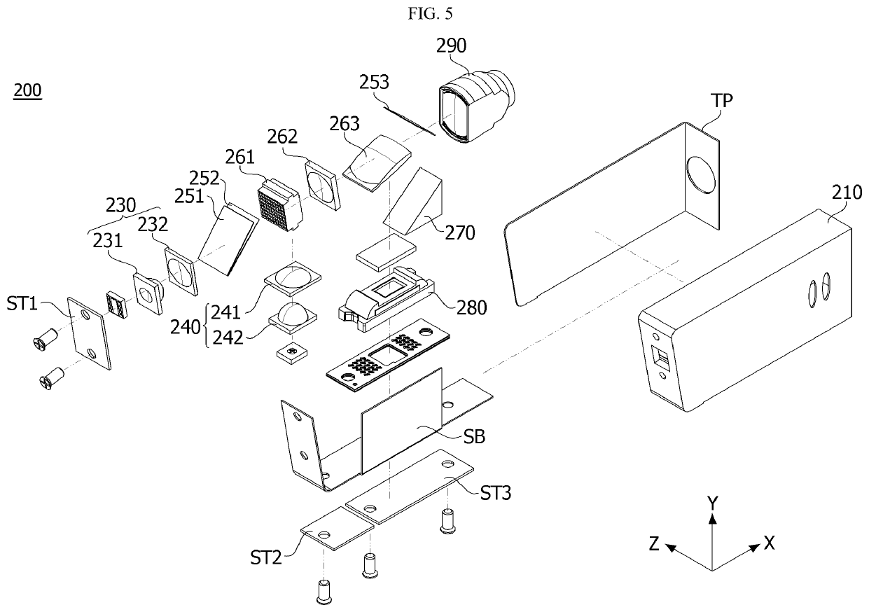

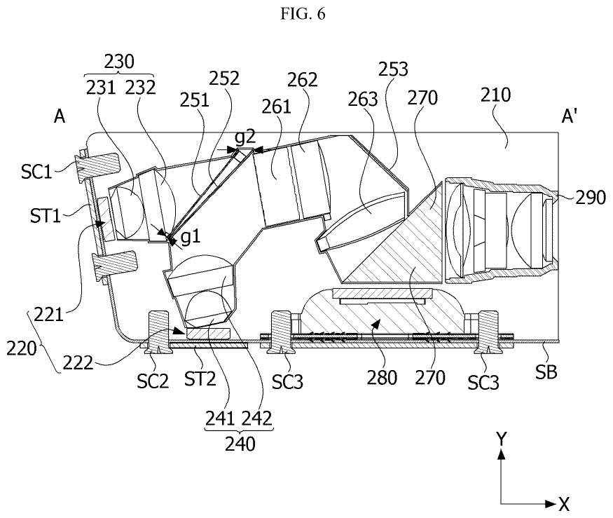

FIG. 3 is a perspective view of the projection device according to the embodiment, FIG. 4 is another perspective view of the projection device according to the embodiment, FIG. 5 is an exploded perspective view of the projection device according to the embodiment, and FIG. 6 is a cross-sectional view taken along line AA′ in FIG. 3.

Referring to FIGS. 3 to 6, the projection device 200 according to the embodiment may include a housing 210, a light source unit 220, a first lens unit 230, a second lens unit 240, a second mirror 252, a first mirror 251, a third lens 261, a fourth lens 262, a reflection unit 253, a fifth lens 263, a prism 270, a light modulator 280, a projection lens unit 290, and a blocking member TP.

The housing 210 may have a space or housing groove in which each component of the projection device 200 is accommodated or disposed. The housing 210 may be located on an outer side of the projection device 200. For example, the light source unit 220, the first lens unit 230, the second lens unit 240, the second mirror 252, the first mirror 251, the third lens 261, the fourth lens 262, the reflection unit 253, the fifth lens 263, the prism 270, the light modulator 280, and the projection lens unit 290 may be disposed in the housing 210.

Further, the housing 210 may have a structure that is open on one side. Accordingly, each of the components described above may be assembled through the open area or surface. Furthermore, the blocking member TP, which will be described below, may be disposed on the open area or surface of the housing 210.

The housing 210 may have various shapes. For example, the housing 210 may have a hexahedral structure. Accordingly, the projection device according to the embodiment may be easily mounted on the electronic device. In addition, the projection device according to the embodiment may be easily miniaturized or made compact.

The light source unit 220 may be disposed in the housing 210. The light source unit 220 may be disposed adjacent to any one of outer side surfaces of the housing 210.

The light source unit 220 may include at least one light source. In the embodiment, the light source unit 220 may include a first light source 221 and a second light source 222. The first light source 221 and the second light source 222 may be located adjacent to different surfaces within the housing 210. A detailed description thereof will be provided below.

In addition, the first light source 221 and the second light source 222 may emit light in different wavelength bands or colors. One of the first light source 221 and the second light source 222 may emit light in a wavelength band different from that of the other. One of the first light source 221 and the second light source 222 may emit at least two of red, green, and blue light. In addition, the other may emit the remaining light. For example, the first light source 221 may emit light having a green wavelength. For example, in the first light source 221, green wavelength light may have the center wavelength. In addition, the second light source 222 may emit red and blue light. For example, in the second light source 222, red and blue light may have the center wavelength.

In addition, the first light source 221 and the second light source 222 may each have a diagonal length of several millimeters (mm). For example, the first light source 221 and the second light source 222 may each have a diagonal length of 1.635 mm.

Further, in the projection device according to the embodiment, a first direction may correspond to an “X-axis direction” in the drawings. The first direction may correspond to a direction from the first light source 221 toward the projection lens unit 290. Alternatively, the first direction may correspond to a direction from a first surface of the housing 210 toward a third surface thereof. Furthermore, a second direction may correspond to a Y-axis direction in the drawings. The second direction may be a direction perpendicular to the first direction. A third direction may be a direction perpendicular to the first direction and the second direction. In addition, the third direction may correspond to a “Z-axis direction” in the drawings.

Further, in the light source unit 220, the first light source 221 and the second light source 222 may emit light in different directions. In other words, a direction of light emission from the first light source 221 and a direction of light emission from the second light source 222 may not be parallel to each other.

The lens units in the projection device may be located at the rear end of the light source unit. In the embodiment, the lens units may include the first lens unit 230 located at the rear end of the first light source 221 and the second lens unit 240 located at the rear end of the second light source 222.

The first lens unit 230 may be disposed adjacent to the first light source 221. Light emitted from the first light source 221 may pass through the first lens unit 230. The first lens unit 230 may be located on the side of the first light source 221 in the first direction (X-axis direction). Alternatively, the first lens unit 230 may be located in a direction in which light is emitted from the first light source 221.

The second lens unit 240 may be disposed adjacent to the second light source 222. Light emitted from the second light source 222 may pass through the second lens unit 240. The second lens unit 240 may be located on the side of the second light source 222 in the second direction (Y-axis direction). The second lens unit 240 may be located in a direction in which light is emitted from the second light source 222.

Further, the second light source 222 and the first light source 221 may be disposed apart from each other in the second direction (Y-axis direction). For example, the second light source 222 may be disposed at least partially offset from the first light source 221 in the first direction (X-axis direction). In other words, the second light source 222 may not at least partially overlap the first light source 221 in the first direction (X-axis direction).

Further, the first lens unit 230 may be disposed apart from the second lens unit 240 in the second direction (Y-axis direction). For example, the second lens unit 240 may be disposed at least partially offset from the first lens unit 230 in the first direction (X-axis direction). In other words, the second lens unit 240 may not at least partially overlap the first lens unit 230 in the first direction (X-axis direction).

The first lens unit 230 may include at least one lens. The first lens unit 230 may include a 1-1 lens 231 and a 1-2 lens 232.

The 1-1 lens 231 may be disposed such that light emitted from the first light source 221 is incident thereon. The 1-1 lens 231 may be disposed at the rear end of the first light source 221. In the present embodiment, the rear end is described based on the traveling direction of light emitted from the light source. In addition, the light may be emitted from the light source and output to the outside through the projection lens unit 290. Accordingly, the projection lens unit 290 may be located at the rear end of the light source unit.

The 1-1 lens 231 may overlap the first light source 221 in the first direction (X-axis direction). In addition, the 1-2 lens 232 may be disposed such that light passing through the 1-1 lens 231 is incident thereon. The 1-2 lens 232 may be located at the rear end of the 1-1 lens 231. Based on the traveling direction of light emitted from the first light source 221, the first light source 221, the 1-1 lens 231, and the 1-2 lens 232 may be sequentially disposed.

The 1-2 lens 232 may overlap the first light source 221 and the 1-1 lens 231 in the first direction (X-axis direction). Accordingly, the 1-1 lens 231 and the 1-2 lens 232 may collect the light emitted from the first light source 221.

With this configuration, it is possible to reduce the loss of light emitted from the light source unit (e.g., the first light source) and facilitate a reduction in volume of the projection device.

The second lens unit 240 may include at least one lens. The second lens unit 240 may include a 2-1 lens 241 and a 2-2 lens 242.

The 2-1 lens 241 may be disposed such that light emitted from the second light source 222 is incident thereon. The 2-1 lens 241 may be disposed at the rear end of the second light source 222.

The 2-1 lens 241 may overlap the second light source 222 in the second direction (Y-axis direction). In addition, the 2-2 lens 242 may be disposed such that light passing through the 2-1 lens 241 is incident thereon. The 2-2 lens 242 may be located at the rear end of the 2-1 lens 241. Based on the traveling direction of light emitted from the second light source 222, the second light source 222, the 2-1 lens 241, and the 2-2 lens 242 may be sequentially disposed. The 2-2 lens 242 may be located above the 2-1 lens 241. In the present specification, the term “above” refers to the side in the second direction (Y-axis direction). For example, the 2-2 lens may be disposed above the 2-1 lens, and the 2-1 lens may be located below the 2-2 lens.

Further, the 2-1 lens 241 may be located on the second light source 222.

The 2-2 lens 242 may overlap the second light source 222 and the 2-1 lens 241 in the second direction (Y-axis direction). Accordingly, the 2-1 lens 241 and the 2-2 lens 242 may collect light emitted from the second light source 222.

With this configuration, it is possible to reduce the loss of light emitted from the light source unit (e.g., the second light source) and facilitate a reduction in volume of the projection device.

In the first lens unit 230 and the second lens unit 240, the lenses (i.e., the 1-1 lens and the 2-1 lens) adjacent to the light sources may be first collimator lenses, and the lenses (i.e., the 1-2 lens and the 2-2 lens) adjacent to the mirrors may be second collimator lenses.

In this case, the lenses adjacent to the light sources in the first lens unit 230 and the second lens unit 240 satisfy Equation 1 below.

$$E = π {A ( n sin θ )}^{2} = \frac{π A}{4 {( F )}^{2}} \qquad [ Equation 1 ]$$

At this time, an etendue of the lens unit may be equal to an etendue of the light source (e.g., a light-emitting diode (LED)).

Here, A represents a surface area, which may be calculated as “πr².” In addition, n denotes a refractive index of the lens unit. Further, θ denotes an incident angle of light on the lens unit. In addition, F denotes a focal length of the lens unit.

In addition, the lenses adjacent to the mirrors in the first lens unit 230 and the second lens unit 240 satisfy Equation 2 below.

Focal length of lens adjacent to light source:Focal length of lens adjacent to mirror=Area of light source:Target illumination area [Equation 2]

Accordingly, Table 1 below may be applied to the first lens unit and the second lens unit according to the embodiment.

TABLE 1

| Item | Value | |
|---|---|---|
| Etendue (LED) | 5.0381 | |
| LED D (active area) | 1.635 | mm |
| LED angle | 60 | deg |
| 1st collimator lens D | 4 | mm |
| 1st collimator lens θ | 20.931 | deg |

| | |
|---|---|
| 1st collimator lens Fno | 1.400 |
| 1st collimator lens EFL | 5.599 |
| 2nd collimator lens EFL | 8.379 |

In addition, in each lens unit, a diagonal length of the lens adjacent to the light source may be several mm. For example, the diagonal length of the lens adjacent to the light source in each lens unit may be 4 mm. In addition, the shape and optical characteristics of each lens in the lens unit may be determined based on Equations 1 and 2 and Table 1 described above. The first mirror 251 and the second mirror 252 may be located at the rear end of the first lens unit 230 or the second lens unit 240. For example, the first mirror 251 and the second mirror 252 may be located on the side of the first light source 221 in the first direction or located on the side of the first lens unit 230 in the first direction (X-axis direction). In addition, the first mirror 251 and the second mirror 252 may be disposed apart from the first light source 221 or the first lens unit 230 in the first direction (X-axis direction). In addition, the first mirror 251 and the second mirror 252 may transmit light emitted from the first light source 221 (or the second light source), and light transmitted through (or emitted from) the first lens unit 230 (or the second lens unit).

More specifically, the first mirror 251 and the second mirror 252 may transmit light emitted from the first light source 221 and the first lens unit 230. In addition, the first mirror 251 and the second mirror 252 may reflect light emitted from the second light source 222 and light transmitted through the second lens unit 240. In addition, the second mirror 252 may transmit light that has passed through the first mirror 251. With this configuration, light emitted from the first light source 221 and the second light source 222 may be incident on the third lens 261 at the rear end, while being converged by the first and second lens units. Accordingly, light necessary for optical modulation or image generation may be incident on the light modulator 280.

Furthermore, the second mirror 252 may be disposed at the rear end of the first mirror 251. The first mirror 251 and the second mirror 252 may be inclined at predetermined angles with respect to an X-axis or Y-axis. In addition, the first mirror 251 and the second mirror 252 may have different angles of inclination with respect to the X-axis or Y-axis.

Further, a separation distance between one end of the first mirror 251 and one end of the second mirror 252 may be the same as or different from a separation distance between the other end of the first mirror 251 and the other end of the second mirror 252. For example, a separation distance g1 between one end of the second mirror 252 and one end of the first mirror 251 may be different from a separation distance g2 between the other end of the second mirror 252 and the other end of the first mirror 251. In addition, the separation distance g1 between one end of the second mirror 252 and one end of the first mirror 251 may be smaller than the separation distance g2 between the other end of the second mirror 252 and the other end of the first mirror 251.

Further, the first mirror 251 and the second mirror 252 may have different lengths. For example, the lengths of the first mirror 251 and the second mirror 252 on an XY plane may be different from each other. For example, the length of the second mirror 252, which is disposed at the rear end, may be greater than the length of the first mirror 251.

Further, the first mirror 251 and the second mirror 252 may include dichroic mirrors. The first mirror 251 may include a dichroic mirror for red, and the second mirror 252 may include a dichroic mirror for blue. Accordingly, the first mirror 251 may reflect light in a red wavelength band, and the second mirror 252 may reflect light in a blue wavelength band.

The third lens 261 may be disposed behind the second mirror 252 and the first mirror 251. The third lens 261 may at least partially overlap the second mirror 252 and the first mirror 251 in the first direction (X-axis direction). Furthermore, the third lens 261 may also at least partially overlap the first light source 221 and the first lens unit 230 in the first direction.

The third lens 261 and a fourth lens 262, which will be described below, may be located between the reflection unit 253 and the lens units 230 and 240. Alternatively, the third lens 261 and the fourth lens 262, which will be described below, may be located between the reflection unit 253 and the first mirror (or the second mirror). The third lens 261 and the fourth lens 262 may be sequentially disposed.

Furthermore, the third lens 261 may transmit light that has passed through the second mirror 252 and light that has been reflected by the first mirror 251. The third lens 261 may include a fly-eye lens (FEL). For example, the third lens 261 may be formed as an array of small lenses. Accordingly, the third lens 261 may focus and condense light rays. In addition, the third lens 261 may focus light rays incident over the entire area into a single point or a small area, or may diffuse the light rays. In the embodiment, the third lens 261 may collect light rays. Furthermore, the third lens 261 may reflect or refract light rays depending on the surface and shape of each lens, or may separate light of a specific wavelength.

The third lens 261 may have a diagonal length of several mm or less. For example, the third lens 261 may have a diagonal length of 0.797 mm.

Further, the third lens 261 may be disposed between the first mirror 251 and the fourth lens 262. The first mirror 251 may be located at the front end of the third lens 261. In addition, the fourth lens 262 may be disposed at the rear end of the third lens 261. As such, in the present specification, each component of the projection device may be located between a component located at the front end and a component located at the rear end. For example, the third lens 261 may be located between at least one of the light source unit, the first lens unit, the second lens unit, the first mirror, and the second mirror, and at least one of the fourth lens, the reflection unit, the fifth lens, the prism, the light modulator, and the projection lens unit. This positional relationship may also be similarly applied to other components.

The fourth lens 262 may be disposed at the rear end of the third lens 261. The fourth lens 262 may be disposed on the side of the third lens 261 in the first direction (X-axis direction). The fourth lens 262 may at least partially overlap the third lens 261 in the first direction (X-axis direction). Similarly, the fourth lens 262 may at least partially overlap the second mirror 252, the first mirror 251, the first lens unit 230, and the first light source 221 in the first direction (X-axis direction). With this configuration, miniaturization of the projection device may be easily achieved.

The fourth lens 262 may include a relay lens. The fourth lens 262 may transmit light emitted from or transmitted through the third lens 261. The fourth lens 262 may transmit light rays from one position to another. That is, the fourth lens 262 may align or change a path of light rays. Furthermore, the fourth lens 262 may adjust the size of illumination or an image (i.e., the maximum area of light rays) provided by an illuminating system, or may compensate for optical differences.

The reflection unit 253 may be located at the rear end of the fourth lens 262. The reflection unit 253 may be located on the side of the fourth lens 262 in the first direction (X-axis direction). The reflection unit 253 may be disposed apart from the fourth lens 262 in the first direction.

In addition, the reflection unit 253 may be inclined at a predetermined angle with respect to the fourth lens 262. The reflection unit 253 may reflect light emitted from the fourth lens 262. For example, light that has passed through the fourth lens 262 may be reflected by the reflection unit 253, directed toward the projection lens unit, and then reflected downward.

The reflection unit 253 may be inclined at a predetermined angle with respect to the fourth lens 262, the first direction, or the like. With this configuration, a length of the projection device according to the embodiment in the second direction may be minimized.

The fifth lens 263 may be disposed at the rear end of the reflection unit 253. The fifth lens 263 may be disposed below the reflection unit 253. The fifth lens 263 may at least partially overlap the reflection unit 253 in the second direction.

The fifth lens 263 may be disposed between the reflection unit 253 and the prism 270.

The fourth lens 262 and the fifth lens 263 may each have a diagonal length of several mm. For example, the fourth lens 262 may have a diagonal length of 3.5 mm, and the fifth lens 263 may have a diagonal length of 6 mm. The diagonal length of each component described above may be varied within a range of 20% to achieve optical performance and implement miniaturization within the illustrated range.

The fifth lens 263 may include a relay lens. The fifth lens 263 may transmit light reflected from the reflection unit 253. The fifth lens 263 may deliver light rays from one position to another. That is, the fifth lens 263 may align or change the path of light rays. Furthermore, the fifth lens 263 may adjust the size of illumination or an image (i.e., the maximum area of light rays) provided by the illuminating system, or may compensate for optical differences.

In addition, the fourth lens 262, the reflection unit 253, and the fifth lens 263 may be sequentially disposed so that light emitted from or transmitted through the second mirror 252 and the first mirror 251 is incident thereon.

Furthermore, an emission surface of the fifth lens 263 may be located above an emission surface of the 2-1 lens 241. In addition, the emission surface of the fifth lens 263 may be located above an emission surface of the 2-2 lens 242.

The prism 270 may be disposed at the rear end of the fifth lens 263. In addition, the prism 270 may be disposed in sequence with the fifth lens 263. Furthermore, the prism 270 may be located below the fifth lens 263. The prism 270 and the fifth lens 263 may partially overlap each other in the second direction. Furthermore, a partial area of the prism 270 may not overlap the fifth lens 263 in the second direction. With this configuration, the prism 270 may transmit light emitted from (or transmitted through) the fifth lens 263, and may reflect the transmitted light, which is incident on and re-emitted from the light modulator 280, toward the projection lens unit 290.

The prism 270 may include a total internal reflection (TIR) prism. As described above, the prism 270 may change the traveling direction of light rays. That is, the prism 270 may perform transmission and reflection of light rays. Specifically, the prism 270 may transmit light emitted from (or transmitted through) the fifth lens 263 and reflect light emitted from the light modulator 280. In addition, the prism 270 may transmit light emitted from the light source unit 220 and reflect light emitted from the light modulator 280. Thus, the path of light may be changed toward the first direction or the projection lens unit. With this configuration, miniaturization of the projection device according to the embodiment may be achieved.

The prism 270 may be disposed between the light modulator 280 and the projection lens unit 290. In addition, the prism 270 may be disposed between the fifth lens 263 and the light modulator 280.

The light modulator 280 may be disposed at the rear end of the prism 270. The light modulator 280 may emit the light, which has been transmitted through the prism 270, back toward the prism 270.

The light modulator 280 may reflect incident light to project an image. For example, the light modulator 280 may emit or project a video or an image based on an image signal incident through a substrate SB. That is, the light modulator 280 may modulate light emitted from the light source unit 220.

The light modulator 280 according to the embodiment may include a digital micromirror device (DMD). The light modulator 280 may include a plurality of micromirrors. In addition, each mirror may reflect or block light in response to a signal (e.g., a digital signal). In other words, the light modulator 280 may control the state of each mirror based on an image signal applied through the substrate SB, and may project an image corresponding to the image signal. For example, when light is reflected by controlling the mirror, a bright region of the image may be displayed, and when light is blocked, a dark region of the image may be displayed.

Further, the second direction (Y-axis direction) may correspond to a direction perpendicular to a top surface of the light modulator 280. For example, the light modulator 280 may have a diagonal length of several inches or less. The diagonal length of the light modulator 280 may be 0.15 inches or more and 2.0 inches or less. Accordingly, the diagonal length may be easily modified for miniaturization or for achieving size implementation of an image or a light guide device.

The projection lens unit 290 may be disposed at the rear end of the prism 270. When light emitted from the light modulator 280 is reflected by the prism 270, the light reflected by the prism 270 may be incident on the projection lens unit 290. The above-described light may be projected through the projection lens unit 290. The projection lens unit 290 may project the light emitted from the projection device onto a screen or waveguide (or the display unit).

In the embodiment, the projection lens unit 290 may adjust the size of the image so that light rays enter through an entrance pupil diameter (EPD) of the waveguide or the like.

To this end, the projection lens unit 290 according to the embodiment may include a lens barrel 291 and a plurality of lenses (or an optical system) disposed in the lens barrel.

A plurality of lenses L1 to L5 (see FIG. 21) may at least partially overlap the prism 270 in the first direction.

The blocking member TP may be disposed on one outer side surface of the housing 210. Accordingly, the blocking member TP may be disposed on the outer side of each component after the components are accommodated in the housing 210. In the embodiment, the blocking member TP may be disposed on one side of the housing 210 corresponding to a groove of the housing 210. In addition, the blocking member TP may cover each component. With this configuration, the blocking member TP may effectively block the inflow of foreign substances or stray light into the components of the housing 210. Accordingly, image projection of the electronic device or the projection device may be more accurately implemented.

The projection device 200 according to the embodiment may further include the substrate SB, fastening members SC1, SC2, and SC3, and reinforcing plates ST1, ST2, and ST3.

The substrate SB may be electrically connected to the light source unit 220 and the light modulator 280. The light source unit 220 and the light modulator 280 may be disposed on the substrate SB. In addition, the substrate SB may be disposed in the housing 210. For example, the substrate SB may be disposed along the outer side surface of the housing 210.

Operations of the light modulator 280 and the light source unit 220 may be controlled through the substrate SB. The substrate SB may perform communication with a control unit or the like of an external device via wired or wireless communication. For example, a control signal from the outside may be transmitted to the projection device through the substrate SB. In addition, the projection device may output an image based on the transmitted control signal.

The fastening members SC1, SC2, and SC3 may be disposed on an outer side of the substrate SB. Accordingly, bonding strength between the substrate SB, the housing 210, the light source unit 220, and the light modulator 280 may be improved. Furthermore, since the substrate SB is disposed outside the housing 210, the degree of freedom in assembly or design may be increased.

The reinforcing plates ST1, ST2, and ST3 may be disposed on the outer side of the substrate SB. Furthermore, the reinforcing plates ST1, ST2, and ST3 may be stiffeners formed of various materials such as metal, composite materials, or resin (plastic). The reinforcing plates ST1, ST2, and ST3 may be disposed on the outer side of the substrate SB to improve the rigidity and strength of the substrate SB and the housing. For example, the reinforcing plates ST1, ST2, and ST3 may be disposed on the substrate SB in correspondence with the positions of the light source unit 220 and the light modulator 280. With this configuration, deformation due to heat or the like generated by the light source unit 220 and the light modulator 280 may be suppressed. Furthermore, the reinforcing plates ST1, ST2, and ST3 may protect the projection device from external impacts.

The fastening members SC1, SC2, and SC3 may pass through the reinforcing plates ST1, ST2, and ST3.

For example, the fastening members may include a first fastening member SC1, a second fastening member SC2, and a third fastening member SC3. The reinforcing plates may include a first reinforcing plate ST1, a second reinforcing plate ST2, and a third reinforcing plate ST3.

The first fastening member SC1 and the first reinforcing plate ST1 may be located corresponding to the first light source 221. The first fastening member SC1 and the first reinforcing plate ST1 may overlap the first light source 221 in the first direction.

The second fastening member SC2 and the second reinforcing plate ST2 may be located corresponding to the second light source 222. The second fastening member SC2 and the second reinforcing plate ST2 may overlap the second light source 222 in the second direction.

The third fastening member SC3 and the third reinforcing plate ST3 may be located corresponding to the light modulator 280. The third fastening member SC3 and the third reinforcing plate ST3 may overlap the light modulator 280 in the second direction (Y-axis direction).

In addition, the fastening members may pass through the respective reinforcing plates to improve the bonding strength between the substrate and the housing 210. Furthermore, the third fastening member SC3 may pass through the light modulator 280 to improve bonding strength between the light modulator 280, the housing 210, and the substrate SB.

In a modified example, the reinforcing plate may be integrally formed to correspond to the substrate SB, rather than being provided as a plurality of reinforcing plates. That is, the reinforcing plate may have a structure extending from the first light source 221 to the light modulator 280.

In addition, the substrate may be separately disposed to correspond to each light source and the light modulator. In addition, the fastening members may be disposed on a plurality of substrates, respectively. Alternatively, each fastening member may pass through all of the plurality of substrates. Accordingly, the plurality of substrates may be coupled to each other by one fastening member. As a result, the number of fastening members may be variously set to an odd or even number.

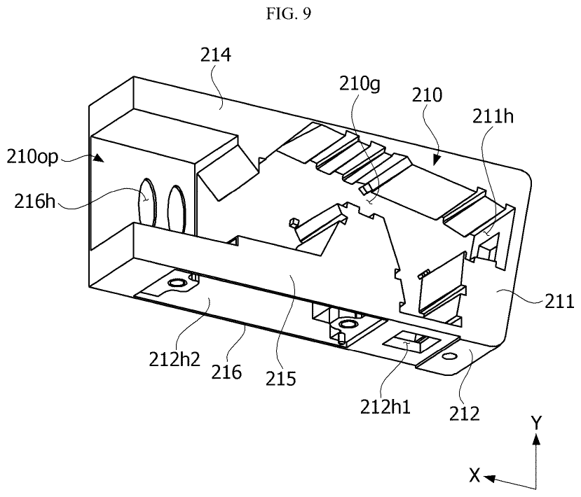

According to the embodiment, one of the plurality of fastening members may couple a substrate (a substrate for the second light source) of the second light source 222, which is one of the light sources, and a substrate (a substrate for the light modulator) of the light modulator 280 to a second surface 212 (in FIG. 9) of the housing 210.

That is, one of the plurality of fastening members may pass through or fasten both the substrate for the second light source and the substrate for the light modulator. That is, one of the fastening members may pass through or couple both the substrate connected to the second light source and the substrate connected to the light modulator. With this configuration, the housing 210 may be coupled to both the substrate for the second light source and the substrate for the light modulator through the third fastening member SC3. Accordingly, the reliability of the projection device according to the embodiment may be improved.

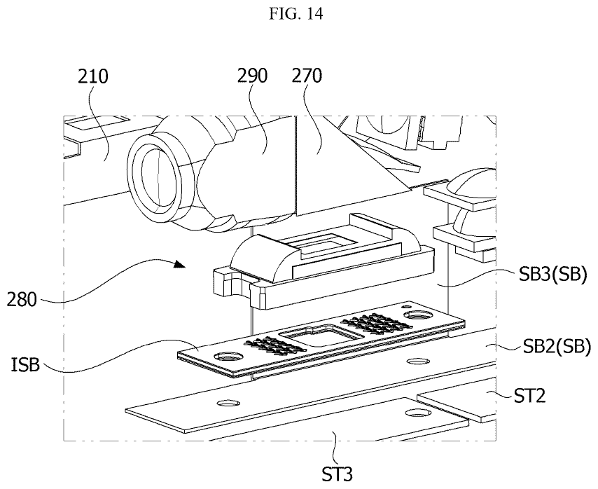

For example, an interposer substrate ISB (see FIG. 14) may be disposed on the substrate SB (see FIG. 14), which will be described below. The interposer substrate may be an element of the light modulator 280. In addition, the third fastening member SC3 may pass through both the interposer substrate and the substrate. Accordingly, the third fastening member SC3 may pass through both the substrate for the second light source and the substrate for the light modulator and may be coupled to the second surface of the housing.

Accordingly, even when the second light source 222 and the light modulator 280 are disposed on the second surface of the housing 210, the number of fastening members (e.g., bolts) coupled to the second surface may be an odd number. Thus, the projection device according to the embodiment may simultaneously provide compactness and improved reliability.

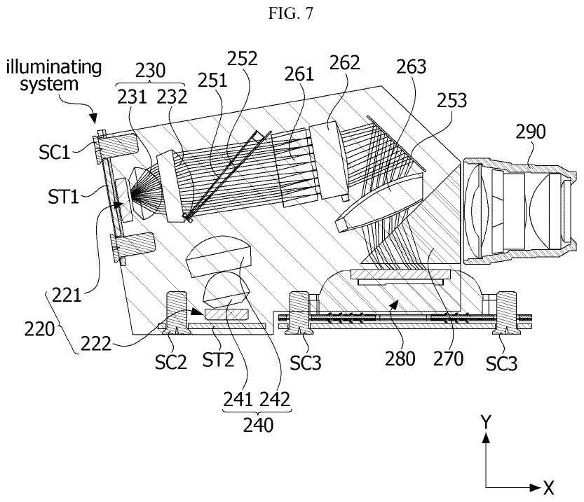

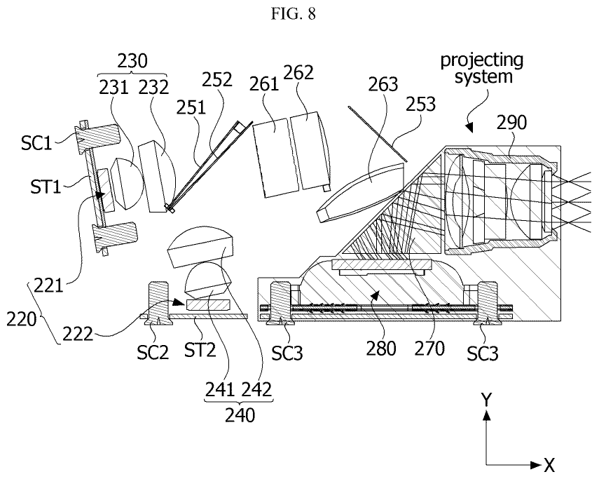

FIGS. 7 and 8 are views of the projection device according to the embodiment with the housing removed.

The projection device according to the embodiment may include an illuminating system and a projecting system (also referred to as a projection system, a projecting unit, a projection unit, a projecting part, or the like).

Referring to FIG. 7, the projection device may include the illuminating system. According to the embodiment, the illuminating system may include the housing 210, the light source unit 220, the first lens unit 230, the second lens unit 240, the second mirror 252, the first mirror 251, the third lens 261, the fourth lens 262, the reflection unit 253, the fifth lens 263, and the prism 270. That is, light emitted from the prism 270 may be incident on the light modulator 280.

The illuminating system may include the prism 270 as a component thereof, receive light (illumination light) from the light source, and emit the light in a predetermined direction. The illumination light may be delivered or provided to the light modulator 280 of the projecting system.

Referring further to FIG. 8, the projecting system may include the prism 270, the light modulator 280, and the projection lens unit 290. The projecting system may include the prism 270 as a component thereof. In the embodiment, the prism 270 may be an element of both the illuminating system and the projecting system.

Furthermore, the projecting system may further include the above-described illuminating system. That is, the projecting system may modulate the illumination light generated by the illuminating system through the light modulator 280, and emit or radiate the modulated light in a predetermined direction through the prism 270 and the projection lens unit 290.

The light modulator 280 may reflect illumination light as patterned light or the like, and the patterned light may pass through the projection lens unit 290 and may be output to the outside of the projection device.

In addition, an optical folding member may be present between an output unit of the projection device and an input unit of a waveguide or wavelength guide. The optical folding member may be formed such that an optical path of the patterned light is folded in at least two different directions.

In the embodiment, as described above, the projection lens unit 290 may include a plurality of lenses. The plurality of lenses may include a first lens, a second lens, a third lens, and a fourth lens. The first lens may be located at the outermost side of the projection device 200. In addition, the first lens may be located closest to the light guide device or to the waveguide or substrate of the light guide device. Accordingly, light transmitted through the first lens may be guided to the substrate or the like of the light guide device.

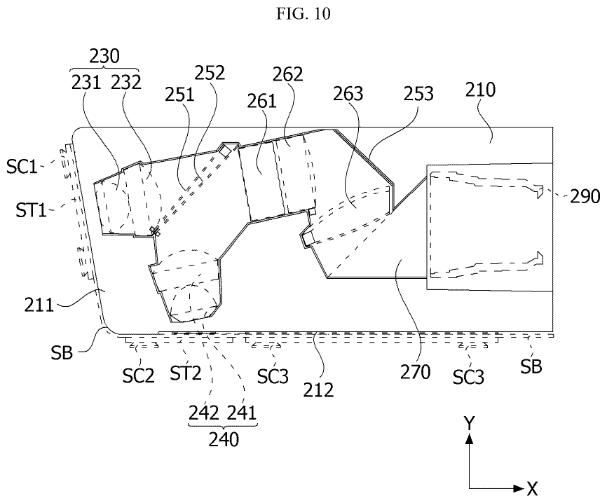

FIG. 9 is a perspective view of the housing of the projection device according to the embodiment, and FIG. 10 is a view illustrating FIG. 9 with other components inserted.

Referring to FIGS. 9 and 10, in the projection device according to the embodiment, the housing 210 may include a plurality of outer side surfaces.

The housing 210 may include a first surface 211, the second surface 212, a third surface 213, a fourth surface 214, a fifth surface 215, and a sixth surface 216.

In the housing 210, the first surface 211 may be connected to the second surface 212, the fourth surface 214, the fifth surface 215, and the sixth surface 216. The second surface 212 may be connected to the first surface 211, the second surface 212, the third surface 213, the fifth surface 215, and the sixth surface 216. The third surface 213 may be connected to the second surface 212, the third surface 213, the fourth surface 214, the fifth surface 215, and the sixth surface 216. The fourth surface 214 may be connected to the first surface 211, the third surface 213, the fourth surface 214, the fifth surface 215, and the sixth surface 216. The fifth surface 215 may be connected to the first surface 211, the second surface 212, the third surface 213, the fourth surface 214, and the sixth surface 216. The sixth surface 216 may be connected to the first surface 211, the second surface 212, the third surface 213, and the fourth surface 214.

The first surface 211 may correspond to the second surface 212. The first surface 211 may face the second surface 212. The third surface 213 may correspond to the fourth surface 214. The third surface 213 may face the fourth surface 214. The fifth surface 215 may face the sixth surface 216. The fifth surface 215 may correspond to the sixth surface 216.

The housing 210 may include a housing groove or a groove 210g. In the housing 210, the groove 210g may have a structure that is open toward the fifth surface 215. Accordingly, the blocking member may be disposed on the fifth surface 215. In addition, each component may be accommodated in the groove 210g of the housing 210 through the opened fifth surface 215. That is, each component of the projection device may be assembled through the fifth surface 215.

Further, the first surface 211 may include a first hole 211h. The substrate SB is disposed on the first surface 211, and an electrical connection between the first light source and the substrate SB may be made through the first hole 211h.

The second surface 212 may include a second hole 212h1 and a third hole 212h2. An electrical connection between the second light source and the substrate SB may be made through the second hole 212h1. An electrical connection between the substrate SB and the light modulator may be made through the third hole 212h2.

The sixth surface 216 may include a fourth hole 216h. Through the fourth hole 216h of the sixth surface 216, optical axis alignment (active alignment) of the projection lens unit and subsequent application of a bonding member (e.g., epoxy) may be easily performed.

An opening 210OP may be formed in the third surface 213 by the groove 210g. The opening 210OP of the housing 210 may correspond to the light output unit of the projection device. That is, light output from the projection device may be provided to a waveguide or the like through the opening 210OP of the housing 210. The opening 210OP may be located adjacent to the projection lens unit.

Furthermore, the groove 210g of the housing 210 may have a step. In the embodiment, a length of the groove 210g of the housing 210 in the Z-axis direction of the groove may be greatest in an area corresponding to the projection lens unit. With this configuration, size adjustment of the lens in the projection lens unit may be easily achieved.

Further, unlike other components, an area adjacent to the light modulator (e.g., an area overlapping the light modulator in the Z-axis direction) on the fifth surface 215 may not be open. As for other components, an opening of the groove 210g may be formed in the fifth surface.

In the embodiment, the first light source 221 may be disposed on the first surface 211. In addition, the second light source 222 and the light modulator 280 may be disposed on the second surface 212.

The first surface 211 of the housing 210 may overlap the light modulator 280 in the first direction (X-axis direction). In addition, the first surface 211 of the housing 210 may overlap the light source unit 220, the first lens unit 230, the second lens unit 240, the second mirror 252, the first mirror 251, the third lens 261, the fourth lens 262, the reflection unit 253, the fifth lens 263, the prism 270, and the projection lens unit 290 in the first direction (X-axis direction).

Further, in the embodiment, the first surface 211 and the second surface 212 of the housing 210 may be in contact with each other and may form a corner (e.g., an edge or a vertex).

As described above, in the projection device according to the embodiment, a volume of the housing 210 may be 3.35 cc or less. For example, a length of the housing 210 in the first direction may be in a range of 31 mm to 37 mm. A length of the housing in the second direction may be in a range of 13 mm to 18 mm. In addition, a length of the housing in the third direction may be in a range of 5 mm to 7 mm. A more compact projection device with reduced volume may be provided based on the above or following descriptions.

Further, in the embodiment, the 2-2 lens 242 may not overlap the fifth lens 263 in the first direction (X-axis direction). In other words, the 2-2 lens 242 may be disposed to be offset from the fifth lens 263 in the first direction (X-axis direction).

In addition, at least a portion of the 2-1 lens 241 may not overlap the prism 270 and the projection lens unit 290 in the first direction (X-axis direction). In other words, at least a portion of the 2-1 lens 241 may be disposed to be offset from the prism 270 and the projection lens unit 290 in the first direction (X-axis direction).

With this configuration, a space for disposing the light modulator and the prism can be easily secured within the projection device having a small volume.

Further, at least a portion of the light modulator 280 may overlap the 2-1 lens 241. For example, the light modulator 280 may at least partially overlap the 2-1 lens 241 in the first direction (X-axis direction). Accordingly, the second light source and the light modulator may be disposed on the substrate SB provided on the second surface 212, thereby securing ease of assembly and the like.

The projection lens unit 290 may not overlap (or superpose) the 2-1 lens 241 in the first direction (X-axis direction). In other words, the projection lens unit 290 may be disposed to be offset from the 2-1 lens 241 in the first direction (X-axis direction).

In addition, the fifth lens 263 may not overlap (or superpose) the 2-1 lens 241 in the first direction (X-axis direction). In other words, the fifth lens 263 may be disposed to be offset from the 2-1 lens 241 in the first direction (X-axis direction).

In addition, at least a portion of the fifth lens 263 may overlap the fourth lens 262 in the second direction (Y-axis direction). Further, the fifth lens 263 may at least partially overlap the fourth lens 262 in the first direction (X-axis direction).

In addition, according to the embodiment, the third lens 261 and the 2-2 lens 242 may not overlap (or superpose) in the first direction (X-axis direction). In other words, the third lens 261 and the 2-2 lens 242 may be disposed to be offset from each other in the first direction (X-axis direction).

With this configuration, the volume of the housing 210 may be minimized, thereby achieving compactness of the electronic device.

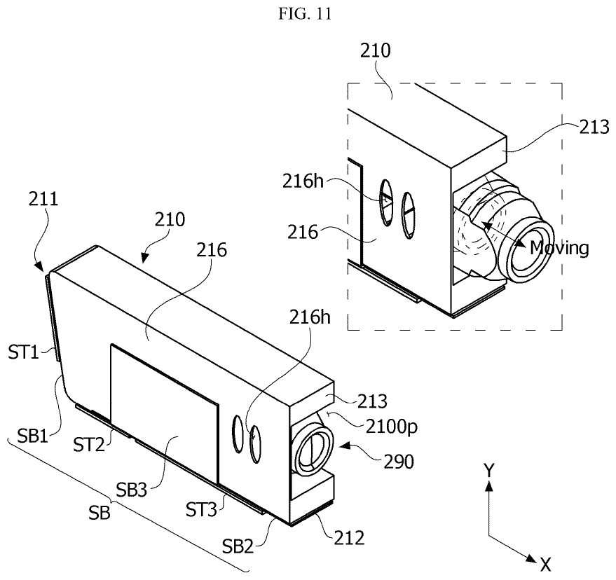

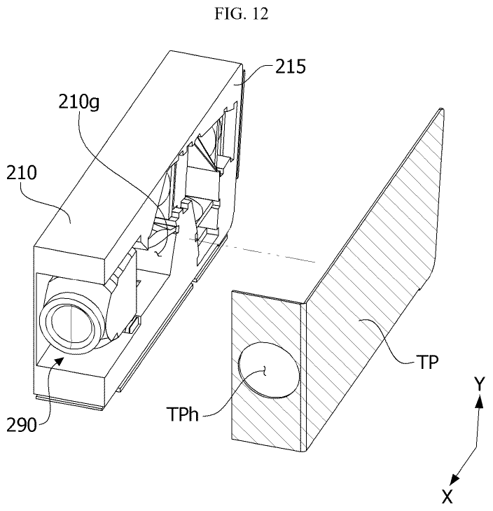

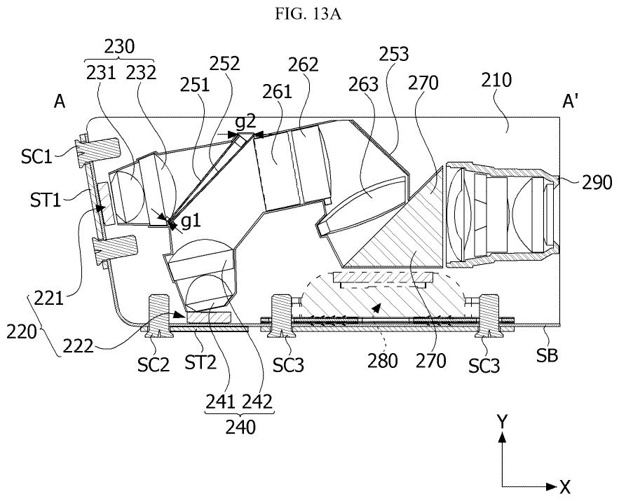

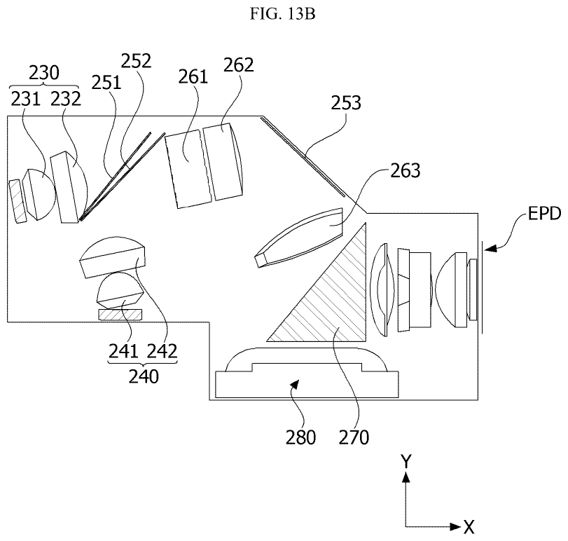

FIG. 11 is a perspective view of the projection device according to the embodiment with a tape removed, FIG. 12 is a perspective view of the projection device according to the embodiment with the tape separated, FIG. 13A is a cross-sectional view of the projection device according to the embodiment, FIG. 13B is another example of FIG. 13A, and FIG. 14 is an exploded perspective view of the light source unit in the projection device according to the embodiment.

Referring to FIGS. 11 to 13A, in the projection device according to the embodiment, the substrate SB may be disposed on the outer side surface (or a surface) of the housing 210 on which the first light source, the second light source, and the light modulator are disposed. In addition, the substrate SB may also be disposed on the surface on which the first light source, the second light source, and the light modulator are not mounted.

In the embodiment, the substrate SB may include a first sub-substrate SB1, a second sub-substrate SB2, and a third sub-substrate SB3. The first sub-substrate SB1 may be disposed on the first surface 211 of the housing 210. The first sub-substrate SB1 may be electrically connected to the first light source. The second sub-substrate SB2 may be disposed on the second surface 212. The second sub-substrate SB2 may be electrically connected to the second light source.

The first sub-substrate SB1 may be formed as a structure that is either separate from or integrated with the second sub-substrate SB2. The second sub-substrate SB2 may have a structure extending in the first direction from one end of the first sub-substrate SB1.

The third sub-substrate SB3 may be disposed on the sixth surface 216. The third sub-substrate SB3 may have a structure in which the second sub-substrate SB2 extends in the third direction from one side thereof. Accordingly, the bonding strength between the substrate SB and the housing may be improved. Furthermore, heat dissipation through the substrate SB may be facilitated.

Further, there may be at least one fourth hole 216h in the sixth surface 216. For example, when there are a plurality of fourth holes 216h, the plurality of fourth holes 216h may be sequentially disposed in the first direction. The fourth hole 216h may overlap the projection lens unit 290 in the third direction. Accordingly, a bonding member (e.g., epoxy) introduced through the fourth hole 216h may be evenly distributed over the projection lens unit 290. In addition, before applying the bonding member, the projection lens unit 290 may be moved in the first direction as described above. For example, the movement of the projection lens unit 290 may be performed using a gripper.

In addition, the blocking member TP may be disposed on the fifth surface 215. The blocking member TP may be larger than the opening of the fifth surface corresponding to the groove 210g of the housing 210.

Furthermore, the blocking member TP may have a structure that bends or extends into the sixth surface 216. Accordingly, the blocking member TP may cover the components within the housing 210. As a result, unnecessary light may be inhibited from entering areas other than the lenses of the projection lens unit 290 through the opening 210OP on the sixth surface 216. In addition, the blocking member TP may include a member hole TPh disposed in an area corresponding to the sixth surface 216. Through the member hole TPh, light output from the projection lens unit 290 or the projection device may be provided to a waveguide or the like.

Referring further to FIG. 13B, the second light source and the second lens unit 240 may overlap the light modulator 280 in the first direction. In this case, as described above, the miniaturization of the projection device may be achieved.

In addition, the second light source and the second lens unit 240 may not at least partially overlap the light modulator 280 in the first direction. The second light source and the second lens unit 240 may be disposed apart from the light modulator 280 in the second direction. Thus, the degree of design freedom for each component may be improved, and optical performance enhancement may be facilitated. Furthermore, as will be described below, the lens unit, the first mirror 251, the second mirror 252, the third lens 261, the fourth lens 262, the reflection unit 253, and the fifth lens 263 may be disposed to be inclined with respect to the first direction, thereby achieving miniaturization of the projection device.

Further, the second light source and the second lens unit 240 may overlap the prism 270 in the first direction. In addition, the second light source and the second lens unit 240 may also overlap the projection lens unit in the first direction. In addition, the second light source and the second lens unit 240 may at least partially overlap the fifth lens 263 in the first direction. For example, in the second lens unit 240, both the 2-1 lens 241 and the 2-2 lens 242 may overlap the fifth lens 263 in the first direction.

Referring to FIG. 14, the light modulator 280 may include a DMD as described above. Furthermore, the light modulator 280 may be connected to the second sub-substrate SB2 of the substrate. The light modulator 280 may further include the interposer substrate ISB. The interposer substrate ISB may be further disposed between the second sub-substrate SB2 and the DMD. With this configuration, improved input/output count connectivity between the DMD and the substrate may be achieved, and electrical connection to traces may be facilitated. The substrate SB may be electrically connected to the DMD through surface mount technology (SMT) or the like. Furthermore, the substrate SB may be bonded to the housing 210 by a bonding member (e.g., epoxy) or the like.

In a modified example, the DMD may be connected to the substrate SB without the interposer substrate. In the absence of the interposer substrate, screw fastening may not be required. Accordingly, mass productivity of the projection device may be improved.

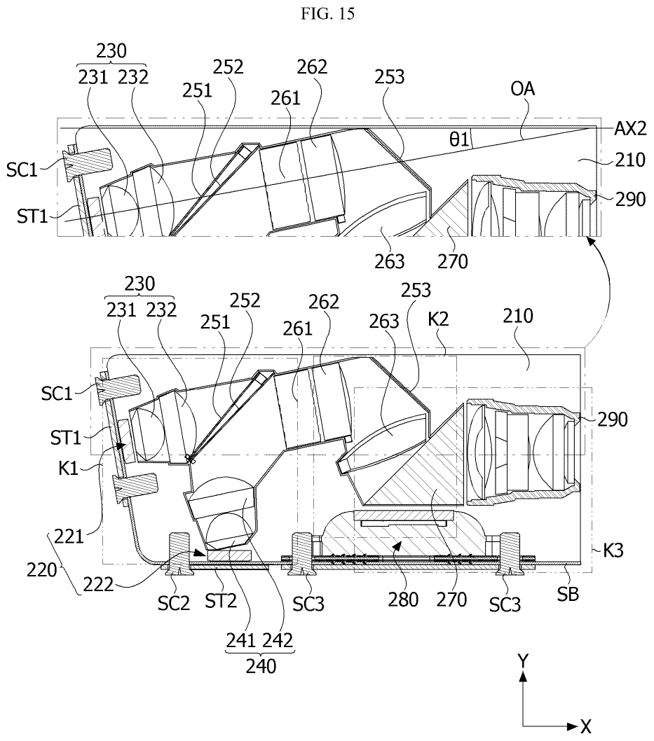

FIG. 15 is a cross-sectional view of the projection device according to the embodiment.

Referring to FIG. 15, in the projection device, the light source unit 220, the first lens unit 230, the second lens unit 240, the second mirror 252, first mirror 251, the third lens 261, the fourth lens 262, and a third mirror 253 may be disposed to be inclined with respect to the top surface of the housing 210 or the light modulator 280. In addition, the light source unit 220, the first lens unit 230, the second lens unit 240, the second mirror 252, the first mirror 251, the third lens 261, the fourth lens 262, and the third mirror 253 may be disposed to be inclined with respect to a cross section (or axis) AX1 or AX2 that is parallel to the top surface of the housing 210 or the light modulator 280. Hereinafter, the inclination angle is described with reference to the corresponding surface or a cross section (or axis) parallel to the corresponding surface.

In addition, the cross section (or axis) AX2 parallel to the top surface of the housing 210 may also be parallel to the cross section (or axis) AX1 parallel to the top surface of the light modulator 280. In addition, the cross section (or axis) AX1 or AX2, which is parallel to the top surface of the light modulator 280, may be parallel to a plane (XZ) or the first direction (X-axis direction).

In addition, the light source unit 220, the first lens unit 230, the second lens unit 240, the second mirror 252, the first mirror 251, the third lens 261, the fourth lens 262, and the third mirror 253 may be disposed to have an inclination angle θ1 with respect to the cross section (or axis) AX1 or AX2 that is parallel to the top surface of the housing 210 or the light modulator 280. Accordingly, a separation distance in the second direction (Y-axis direction) from the top surface of the light modulator 280 to the center of any one of the light source unit 220, the first lens unit 230, the second lens unit 240, the second mirror 252, the first mirror 251, the third lens 261, the fourth lens 262, or the third mirror 253 may increase toward the reflection unit or in the first direction.

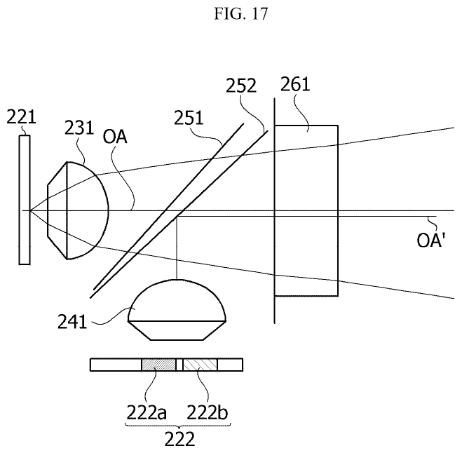

For example, the light source unit 220, the first lens unit 230, and the reflection unit 253 may be sequentially disposed along an optical axis OA and may be disposed to have the inclination angle θ1 with respect to the cross section (or axis) AX1 or AX2 that is parallel to the top surface of the housing 210 or the light modulator 280 described above. The inclination angle θ1 may be in a range of 5° to 10°. Preferably, the inclination angle θ1 may be 7°. At this time, the inclination angle θ1 may correspond to an angle formed counterclockwise between the optical axis OA and the cross section (or axis) AX1 or AX2 that is parallel to the top surface of the housing 210 or the light modulator 280 in the cross section or drawing. Furthermore, the optical axis OA is illustrated based on the first light source. An optical axis OA′ (see FIG. 17) for the second light source may at least partially overlap the optical axis OA for the first light source. In addition, the inclination angle θ1 for the second light source 222 may correspond to an angle formed between the optical axis between the second light source 222 and the first mirror 251 and a plane (or axis) perpendicular to the cross section (or axis) AX1 or AX2. With this configuration, interference among the components within the housing 210 may be avoided, and a height of the projection device in the second direction may be reduced, thereby easily realizing miniaturization.

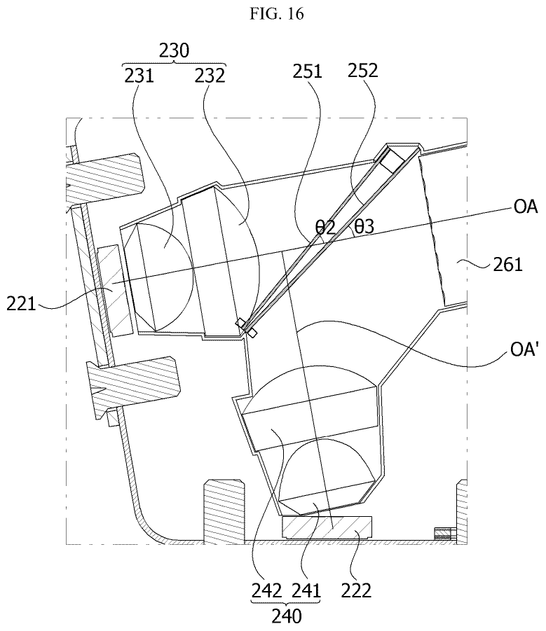

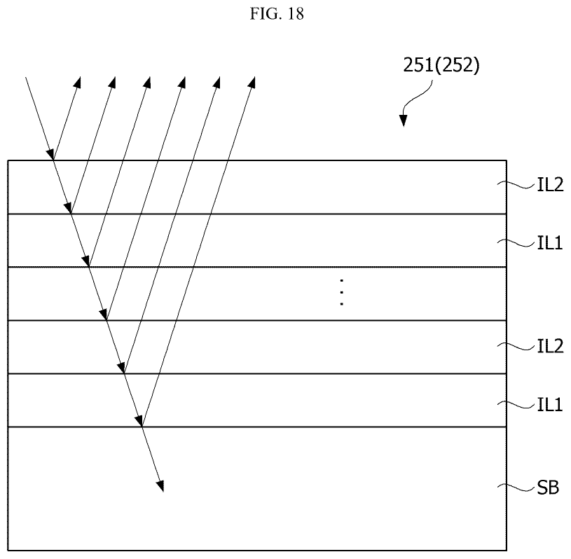

FIG. 16 is an enlarged view of portion K1 in FIG. 15, FIG. 17 is a perspective view of the light source unit, the first lens unit, the second lens unit, the first mirror, the second mirror, and the third lens of the projection device according to the embodiment, and FIG. 18 is a conceptual view of the first mirror and the second mirror of the projection device according to the embodiment.

Referring to FIG. 16, since the light source unit 220 includes the first light source 221 and the second light source 222 that emit light in different directions, the projection device includes the second mirror 252 and the first mirror 251, which are disposed at different inclination angles. The second mirror 252 may transmit light emitted from the first light source 221. In addition, the first mirror 251 may reflect light emitted from the second light source 222 and transmit light emitted from the first light source 221.

According to the embodiment, as described above, the second mirror 252 and the first mirror 251 may be inclined at different angles with respect to the optical axis OA.

The second mirror 252 may have an inclination angle θ2 in a range of 390 to 460 with respect to the optical axis OA. The inclination angle θ2 of the second mirror 252 with respect to the optical axis OA may be in a range of −6° to 0° relative to 45° of the optical axis OA. Furthermore, the second mirror 252 may have an inclination angle in a range of 46.7° to 50.7° with respect to the cross section (or axis) AX1 or AX2, which is parallel to the top surface of the housing 210 or the light modulator 280.

The first mirror 251 may have an inclination angle θ3 in a range of 46.7° to 50.7° with respect to the optical axis OA. The inclination angle θ3 of the first mirror 251 with respect to the optical axis OA may be in a range of 1.7° to 5.7° relative to 45° of the optical axis OA. The first mirror 251 may have an inclination angle in a range of 53.7° to 57.7° with respect to the cross section (or axis) AX1 or AX2, which is parallel to the top surface of the housing 210 or the light modulator 280. For example, the second mirror 252 may have an inclination angle of 48.75° with respect to the cross section (or axis) AX1 or AX2, which is parallel to the top surface of the housing 210 or the light modulator 280. In addition, the first mirror 251 may have an inclination angle of 55.71° with respect to the cross section (or axis) AX1 or AX2, which is parallel to the top surface of the housing 210 or the light modulator 280. With this configuration, the manufacturability and performance of the projection device may be improved.

Furthermore, as described above, the second light source 222 may emit red and blue light. In addition, the second light source 222 may have partitioned areas that emit light of different wavelength bands. For example, the area that emits red light and the area that emits blue light may be separated from each other. Accordingly, by allowing the second mirror 252 and the first mirror 251 to have different inclination angles, color separation caused by the second light source 222 emitting light of different wavelength bands may be minimized, and optical centers (OCs) of the first and second light sources may be easily aligned.

Referring further to FIG. 17, the second mirror 252 and the first mirror 251 satisfy Equations 3 and 4 below.

$${Angle}_{Red} = 45 ° - {tan}^{( - 1 )} ( \frac{{shift}_{R}}{{D}_{R}} ) \qquad [ Equation 3 ]$$

$${Angle}_{blue} = 45 ° + {tan}^{( - 1 )} ( \frac{{shift}_{B}}{{D}_{B}} ) \qquad [ Equation 4 ]$$

Here, Angle_{Red} is the angle (inclination angle) formed between the first mirror and the optical axis, and Angle_{blue} is the angle (inclination angle) formed between the second mirror and the optical axis. In addition, Shift_{R,B} represents a separation distance between areas corresponding to different wavelength bands, D_{B} is a diameter or length of the second mirror, and DR is a diameter or length of the first mirror.

For example, when Shift_{R,B} is 0.375 mm, D_{B} may be 5.783 mm, and D_{B} may be 6.621 mm, and when Decenter_{R} is 0.3933 mm, Angle_{Red} may be 41.758°, and Angle_{blue} may be 48.7102°.

Accordingly, the first mirror and the second mirror may be disposed to be inclined in consideration of the optical center (OC) of the second light source, which emits light of different wavelength bands.

Referring to FIG. 18, the first mirror 251 or the second mirror 252 according to the embodiment may be a dichroic mirror. The dichroic mirror may function to separate or combine incident light depending on a wavelength of the light. A surface of the dichroic mirror uses a coating that selectively transmits or reflects light depending on the wavelength, and may also use an anti-reflection (AR) coating to minimize reflectance.

In addition, since the first mirror 251 and the second mirror 252 are formed of dichroic mirrors, angular dependence of the first mirror 251 and the second mirror 252 may increase as the spectral bandwidth becomes narrower. That is, the reflection and transmission characteristics of the first mirror and the second mirror depend on a specific angle (inclination angle), and for example, when the optical spectrum is narrower, the reflection and transmission characteristics of the first mirror (or the second mirror), which is an optical device, may vary depending on the angle. Accordingly, the wavelength of the light that is reflected or transmitted when light rays pass through the first mirror (or second mirror) may vary depending on the angle (or inclination angle). Accordingly, a filter may be additionally disposed depending on the angle (or inclination angle) of the first mirror (or second mirror) with respect to the light that has passed through the preceding first lens unit or second lens unit. For example, the filter may be additionally disposed between the first lens unit and the first mirror, or between the second lens unit and the second mirror. For example, the filter may be a band-pass filter and may be designed or disposed at a normal angle. Furthermore, the first mirror (or second mirror) may be designed or disposed in consideration of the reflection angle and the light path, as described above. With this configuration, desired performance may be easily provided while maintaining a desired wavelength within the spectrum.

In addition, the first mirror 251 may reflect light of a blue wavelength. In addition, the first mirror 251 may transmit light of a green wavelength. In addition, the second mirror 252 may reflect light of a red wavelength and transmit light of a green wavelength.

For example, the first mirror 251 (or the second mirror) may include high-refractive-index layers IL1 and low-refractive-index layers IL2 alternately stacked on the substrate SB. The high-refractive-index layer IL1 may be formed of a material having a higher refractive index than the low-refractive-index layer IL2.

The high-refractive-index layer IL1 and the low-refractive-index layer IL2 may respectively satisfy the Equations 5 and 6 below.

$$tH = λ / 2 nH * cos θ \qquad [ Equation 5 ]$$

$$tL = λ / 2 nL * cos θ \qquad [ Equation 6 ]$$

Here, t_{H} may be a thickness of the high-refractive-index layer, t_{L} may be a thickness of the low-refractive-index layer, n_{H} may be a refractive index of the high-refractive-index layer, n_{L} may be a refractive index of the low-refractive-index layer, and θ may be an angle of reflection of the corresponding component (e.g., the mirror).

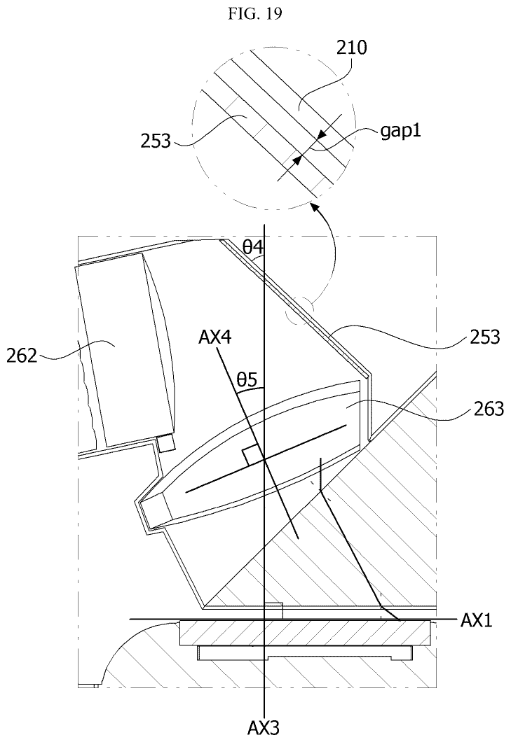

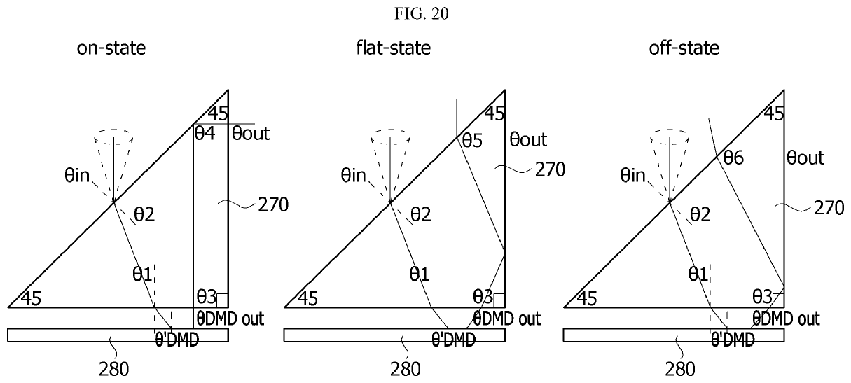

FIG. 19 is an enlarged view of portion K2 in FIG. 15, and FIG. 20 illustrates light in the prism according to driving states of the light modulator in the projection device according to the embodiment.

Referring to FIG. 19, in the projection device according to the embodiment, the reflection unit 253 may be disposed a predetermined distance from a sidewall of the groove (housing groove) of the housing 210. For example, the reflection unit 253 may have a reflective surface and an opposite surface facing or opposing the reflective surface. In addition, the opposite surface of the reflection unit 253 may be disposed apart from the sidewall of the groove of the housing 210 by a gap gap1. Furthermore, the opposite surface of the reflection unit 253 may be parallel to the sidewall of the groove of the housing 210. The sidewall of the housing groove facing the opposite surface of the reflection unit 253 may serve as a reference surface for components or assemblies. For example, the gap gap1 may be in a range of 0.5 mm to 5 mm. With this configuration, ease of assembly may be improved.

In addition, the reflection unit 253 and the fifth lens 263 may be disposed to be inclined with respect to the cross section (or axis) AX1 or AX2 that is parallel to the top surface of the housing 210 or the light modulator 280. Furthermore, the reflection unit 253 and the fifth lens 263 may be disposed to be inclined with respect to a cross section (or axis) AX3 that is perpendicular to the top surface of the light modulator 280. The cross section (or axis) AX3 that is perpendicular to the top surface of the light modulator 280 may be perpendicular to the cross section (or axis) AX1 or AX2 that is parallel to the top surface of the housing 210 or the light modulator 280.

Inclination angles θ4 and θ5 of the reflection unit 253 and the fifth lens 263 with respect to the cross section (or axis) AX3 may be influenced by the control of an angle of a principal ray incident on the light modulator 280.

In the embodiment, the reflection unit 253 may have the inclination angle θ4 with respect to the cross section (or axis) AX3 that is perpendicular to the top surface of the light modulator 280. In addition, the inclination angle θ4 of the reflection unit 253 may be in a range of 48° to 56°. In addition, the fifth lens 263 may have the inclination angle θ5 with respect to the cross section (or axis) AX3 that is perpendicular to the top surface of the light modulator 280. The inclination angle θ5 of the fifth lens 263 may be in a range of 1.8° to 5.8°. With this configuration, light efficiency and the like may be improved according to the principal ray incident on the light modulator.

For example, since a principal ray corresponding to twice the on-state angle (e.g., 17°) of the light modulator 280 must be incident, the principal ray needs to be incident on the prism at a predetermined angle (e.g., 3.831°) through the reflection unit 253 and the fifth lens 263. In this case, the inclination angle of the reflection unit 253 may be 52°, and the inclination angle of the fifth lens 263 may be 3.8°. As a result, the projection device can provide improved optical performance.

Further, referring further to FIG. 20, the light modulator 280 and the prism may satisfy Table 2 below.

TABLE 2

| | |
|---|---|
| Item | Value |

| | |
|---|---|
| Prism RI (refractive index) | 1.717 |
| TIR angle | 35.612 deg |
| TIR incidence angle (θ in) | 3.831 deg |
| Half angle DMD out | 11.696 deg |
| Cone angle | 11.43 deg |

| — | | [Deg] | Difference [deg] |
|---|---|---|---|
| θ_{DMD} | C-down | 45.700 | 11.700 |
| | Center | 34.000 | — |
| | C-up | 26.069 | 7.931 |
| θout | C-down | 11.700 | 11.700 |
| | Center | 0.000 | — |
| | C-up | −7.931 | 7.931 |
| θ_{TIR} | C-down | 51.7815 | 16.170 |
| [on- | Center | 45.000 | 9.388 |
| state] | C-up | 40.392 | 4.780 |
| θ_{TIR} | C-down | 20.371 | −15.241 |
| [flat- | Center | 25.997 | −9.614 |
| state] | C-up | 30.174 | −5.438 |
| θ_{TIR} | C-down | 10.047 | −25.565 |
| [off- | Center | 12.324 | −23.288 |
| state] | C-up | 14.693 | −20.918 |

Here, a TTR angle may refer to a critical angle for total internal reflection. In addition, “Difference” indicates a difference value between θ_{TIR} and the TIR angle. θ_{DMD} represents an angle of light incident on the light modulator. Thus, in an on-state, since a margin from the TIR angle is about 5° or more, optical performance may be maintained during projection. Furthermore, when the light modulator is in a flat-state, the margin from the TIR angle may be less than −5°, which may cause a change in the light path. Furthermore, when the light modulator is in an off-state, the margin from the TIR angle is less than about −14°, which may cause a change in the light path. Here, the on-state refers to a state in which the mirrors are tilted in a specific direction, and in this case, a display can be generated. In addition, the flat-state refers to a state in which all mirrors are aligned horizontally. In addition, the off-state refers to a state in which all mirrors are tilted in another direction or are deactivated. According to the embodiment, an incident angle of a principal ray of the light, which is reflected by the reflection unit and incident on the prism 270, may be in a range of 3° to 4°. With this configuration, light efficiency can be improved, and stray light can be effectively eliminated.

FIG. 21 is an enlarged view of portion K3 in FIG. 15.

Referring to FIG. 21, in the projection device according to the embodiment, the projection lens unit 290 may be disposed to be parallel to or inclined with respect to the cross section (or axis) AX1 or AX2, which is parallel to the top surface (or a bottom surface) of the housing 210 or the light modulator 280.

For example, the projection lens unit 290 may be disposed to have an inclination angle θ6 in a range of 5° to 10° with respect to the cross section (or axis) AX1 or AX2, which is parallel to the top surface (or the bottom surface) of the housing 210 or the light modulator 280. With this configuration, miniaturization and performance improvement of the projection device may be provided.

In addition, when the projection lens unit 290 is disposed parallel to the cross section (or axis) AX1 or AX2, which is parallel to the top surface (or the bottom surface) of the housing 210 or the light modulator 280, ease of assembly and manufacturing convenience may be improved.

Furthermore, first to fifth projection lenses L1 to L5, which are sequentially arranged along the optical axis in the projection lens unit 290, satisfy Tables 3 to 7 below.

TABLE 3

| | | | Thickness | | Y Semi- |
|---|---|---|---|---|---|
| Name | Type | Y Radius | (mm) | Material | Aperture |
| Emission-side surface of fifth | Sphere | −19.3932 | 1.034283 | — | 1.767948 |
| projection lens L5 | | | | | |
| Light source-side surface of | Sphere | −4.55956 | 0.547692 | Air | 1.900661 |
| fifth projection lens L5 | | | | | |
| Emission-side surface of fourth | Asphere | −3.07214 | 1.617665 | — | 1.898874 |
| projection lens L4 | | | | | |
| Light source-side surface of | Asphere | −2.45564 | 0.2 | Air | 2.306807 |
| fourth projection lens L4 | | | | | |
| Emission-side surface of third | Asphere | 2.939631 | 0.776961 | — | 2.224086 |
| projection lens L3 | | | | | |
| Light source-side surface of | Asphere | 1.392171 | 1.134614 | Air | 2.305185 |
| third projection lens L3 | | | | | |
| Emission-side surface of | Asphere | −2.8582 | 0.9 | — | 2.459207 |
| second projection lens L2 | | | | | |
| Light source-side surface of | Asphere | −4.79633 | 0.2 | Air | 2.564148 |
| second projection lens L2 | | | | | |
| Emission-side surface of first | Asphere | 3.770544 | 1.95 | — | 2.758181 |
| projection lens L1 | | | | | |
| Light source-side surface of | Asphere | −8.78241 | 0.2 | Air | 2.861366 |
| first projection lens L1 | | | | | |

Here, the units for length, thickness, and the like are in millimeters [mm]. The emission-side surface of each projection lens refers to a surface opposite to the light source-side surface or a surface facing the prism, and the light source-side surface of each projection lens corresponds to the surface facing the prism. Furthermore, a thickness of the emission-side surface of each projection lens represents a thickness of the projection lens itself, while a thickness of the light source-side surface represents a distance between each projection lens and the projection lens or component located on the front end. Furthermore, the sign (positive/negative) of refractive power may be applied according to the table.

TABLE 4

| Fourth | | | |
|---|---|---|---|
| projection lens | | Light source- | |
| Emission-side surface | | side surface | |
| Conic constant (K) | 0 | Conic constant (K) | −4.9204 |
| 4th order | −0.00435943 | 4th order | −0.02522 |
| coefficient (A) | | coefficient (A) | |
| 6th order | −0.00315654 | 6th order | 0.004224 |
| coefficient (B) | | coefficient (B) | |
| 8th order | 0.001453832 | 8th order | −0.00067 |
| coefficient (C) | | coefficient (C) | |
| 10th order | −0.00034646 | 10th order | 4.08E−05 |
| coefficient (D) | | coefficient (D) | |
| 12th order | 2.93E−05 | 12th order | 0 |
| coefficient (E) | | coefficient (E) | |

TABLE 5

| Third projection lens | | Light source- | |
|---|---|---|---|
| Emission-side surface | | side surface | |
| Conic constant (K) | 0 | Conic constant (K) | 0 |
| 4th order | −0.04378559 | 4th order | −0.04379 |
| coefficient (A) | | coefficient (A) | |
| 6th order coefficient (B) | 0.00474903 | 6th order | 0.004749 |
| | | coefficient (B) | |
| 8th order coefficient (C) | −0.00107314 | 8th order | −0.00107 |
| | | coefficient (C) | |
| 10th order coefficient (D) | 1.00E−04 | 10th order | 1.00E−04 |
| | | coefficient (D) | |

TABLE 6

| Second projection lens | | Light source- | |
|---|---|---|---|
| Emission-side surface | | side surface | |
| Conic constant (K) | 0 | Conic constant (K) | 0 |
| 4th order | 0.066083203 | 4th order | 0.022628 |
| coefficient (A) | | coefficient (A) | |
| 6th order | −0.00402059 | 6th order | 0.001532 |
| coefficient (B) | | coefficient (B) | |
| 8th order | 5.53E−05 | 8th order | −0.00054 |
| coefficient (C) | | coefficient (C) | |
| 10th order | −4.45E−05 | 10th order | 6.33E−06 |
| coefficient (D) | | coefficient (D) | |
| 12th order | 6.51E−06 | 12th order | 2.27E−06 |
| coefficient (E) | | coefficient (E) | |

TABLE 7

| First projection lens | | | |
|---|---|---|---|
| Emission- | | Light source- | |
| side surface | | side surface | |
| Conic constant (K) | −7.11161267 | Conic constant (K) | 0 |
| 4th order | −0.00248815 | 4th order | −0.00545 |
| coefficient (A) | | coefficient (A) | |
| 6th order | 0.001028134 | 6th order | 0.000401 |
| coefficient (B) | | coefficient (B) | |
| 8th order | −9.43E−05 | 8th order | 5.44E−05 |
| coefficient (C) | | coefficient (C) | |
| 10th order | −2.43E−06 | 10th order | −7.63E−06 |
| coefficient (D) | | coefficient (D) | |

In the embodiment, the emission-side surface of the fifth projection lens L5 in the projection lens unit 290 may have the largest radius of curvature among the first to fifth projection lenses L1 to L5. In addition, the first projection lens L1 may have the greatest thickness among the first to fifth projection lenses L1 to L5. In addition, the first projection lens L1 may have the largest effective diameter among the first to fifth projection lenses L1 to L5.

With this configuration, an entrance pupil diameter (EPD) may be formed at the rear end of the projection lens unit 290 or outside the projection device, and the size of rays or images may be adjusted so that the light rays enter within the EPD.

Furthermore, a stop may be located within the projection lens unit.

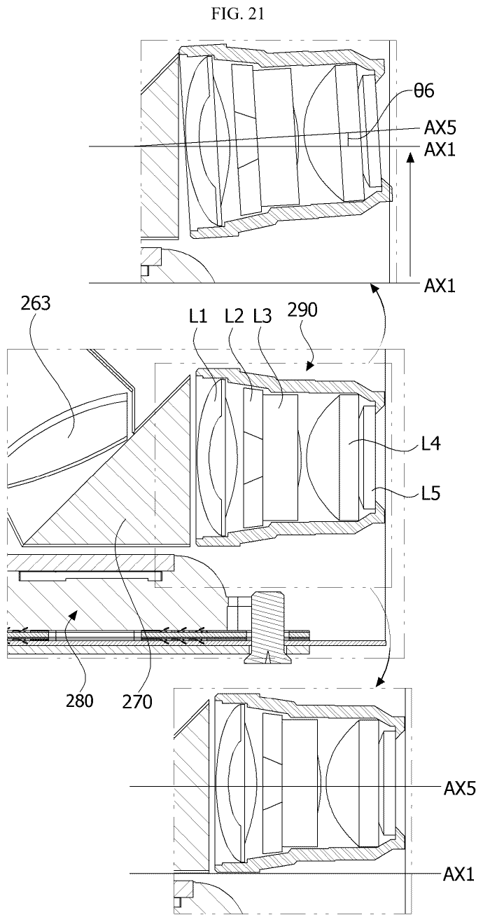

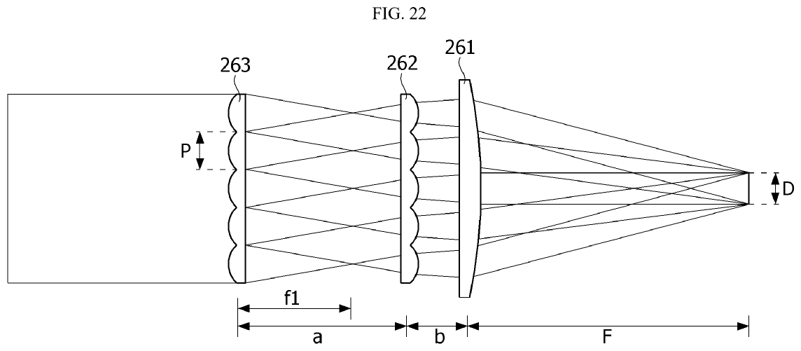

FIG. 22 is a conceptual view of the third lens, the fourth lens, and the fifth lens in the projection device according to the embodiment.

The third lens 261 is a fly-eye lens (FEL), and the fourth lens 262 and the fifth lens 263 are relay lenses that may satisfy the following tables and equations.

Table 8 shows data related to the third lens according to the embodiment. Here, FEL refers to the third lens.

TABLE 8

| Item | X | | Y | | Total |
|---|---|---|---|---|---|
| FEL refractive index | 1.517 | | | | |
| Area ratio | 16 | | 7.779 | | — |
| Number of FELs | 14.342 | ea | 6.973 | ea | 100 ea |
| that can fit | | | | | |
| within 5 mm | | | | | |
| Size of lenslet in FEL | 0.349 | mm | 0.717 | mm | D = 0.797 mm |
| Number of | 15 | ea | 7 | ea | 105 ea |
| fabricated FELs | | | | | |
| FEL fabrication size | 5.229 | mm | 5.019 | mm | — |

| FEL cone angle | 7.7 | deg |
|---|---|---|
| FEL focal length F | 2.9487 | mm |
| FEL radius R | 1.0047 | |
| FEL thickness T | 4.488 | mm |

Here, the number of FELs that can fit within 5 mm may be calculated using an area ratio of 16:7.779, which satisfies the condition ‘number in the X-axis:number in the Y-axis,’ under the constraint that the product of the X and Y counts is 100. In addition, an angle (e.g., a minimum angle θ=7.7°), which reflects the maximum tolerance in the cone angle of the prism, is applied to Equation 7 below for the calculation.

$$F ( focal length of third lens ) = ( D / 2 ) / tan ( 7.7 ° ) \qquad [ Equation 7 ]$$

Here, D refers to a diameter of a lenslet in the third lens.

A radius of the third lens is calculated by Equation 8 below.

$$R ( radius of third lens ) = F \times ( n 2 - n 1 ) / n 2 \qquad [ Equation 8 ]$$

Here, F is a focal length of the third lens, n1 is a refractive index of air, and n2 is a refractive index of the third lens.

Here, F is a focal length of the FEL.

In addition, a thickness of the third lens is calculated using Equations 9 and 10 below.

$$T ( thickness of third lens ) = ( D / 2 ) / tan ( {θ}_{FEL} ) \qquad [ Equation 9 ]$$

Here, θ_{FEL} is an internal incident angle of the third lens and is calculated by Equation 10 below.

$${θ}_{FEL} = {sin}^{- 1} ( sin 7.7 ° / 1.517 ( refractive index of third lens ) ) \qquad [ Equation 10 ]$$

Here, the angle of 7.7° is the minimum angle applied as described above. Furthermore, when light is incident on the prism, the maximum width (or area) after incidence may increase compared to before incidence. For example, when the light has a ratio of 16:9 in horizontal length:vertical length, the ratio may be changed to 11.31:9, 16:12.73, or the like.

Furthermore, the fourth lens and the fifth lens, which are relay lenses, may be applied according to the following equations, tables, and the like.

TABLE 9

| Item | X | Y | Total |
|---|---|---|---|
| Size of lenslet in FEL | 0.349 mm | 0.717 mm | D = 0.797 mm |
| FEL fabrication size | 5.229 mm | 5.019 mm | — |

| | | |
|---|---|---|
| FEL focal length F | 2.9487 | mm |
| FEL thickness T | 4.488 | mm |
| Relay lens focal length F | 15.0394 | mm |
| TIR incidence | −16.2642 | deg |
| angle (ATIR prism) | | |

In the embodiment, the fourth lens, which is a first relay lens, and the fifth lens, which is a second relay lens, may be applied according to the following description. That is, a position, an angle, and the like of the lens may be set. First, when the fifth lens is applied, an EPD may be set at a position of the light modulator, which is a DMD. For example, the EPD may be set to 4.065 mm. In addition, a ray with the cone angle and size may be set at a position of the third lens described above. Even when the EPD is taken into account, since a marginal ray angle is wide, the fourth lens may be used to optimize the marginal ray angle. In addition, with the reflection unit and prism described above, the tilt and shift of the fourth lens may be performed to match an incident angle (e.g., 34°) to the light modulator.

In addition, Equations 11 and 12 described below may be applied in association with FIG. 22.

$$D = P \frac{F}{( {f}_{1} {f}_{2} )} [ ( {f}_{1} + {f}_{2} ) - a ] \qquad [ Equation 11 ]$$

$$FEL ( third lens ) focal length : relay lens focal length = FEL ( third lens ) pitch : DMDpitch \qquad [ Equation 12 ]$$

Here, f₂ is a focal length of the fourth lens. In addition, a focal length of the relay lens may refer to a focal length of the fourth lens and/or the fifth lens.

The design values or applied equations for the light source unit, the lens unit (particularly, the lens adjacent to the light source), the third lens, the fourth lens, and the fifth lens, which are described above, may be modified in consideration of the size, miniaturization, and performance of the light modulator. However, when the values fall below the lower limits of the following ranges, problems such as degradation in optical performance may occur, and when the values exceed the upper limits, miniaturization becomes difficult. With respect to these ranges, a diagonal length of each light source may be 1.5 mm or more and 1.7 mm or less. More preferably, the diagonal length of each light source may be 1.6 mm or more and 1.66 mm or less. In addition, the lens (1st collimator lens) adjacent to the light source in the lens unit may have a diagonal length of 3.8 mm or more and 4.2 mm or less. More preferably, the lens (1st collimator lens) adjacent to the light source in the lens unit may have a diagonal length of 3.9 mm or more and 4.1 mm or less. In addition, the third lens, which is a FEL, may have a diagonal length of 0.6 mm or more and 1.2 mm or less. More preferably, the third lens may have a diagonal length of 0.6 mm or more and 1.2 mm or less. More preferably, the diagonal length of the third lens may be 0.7 mm or more and 1.0 mm or less. In addition, a diagonal length of the fourth lens (relay lens 1) may be 3.0 mm or more and 4.0 mm or less. More preferably, the diagonal length of the fourth lens (relay lens1) may be 3.3 mm or more and 3.7 mm or less. A diagonal length of the fifth lens (relay lens 2) may be 5.5 mm or more and 6.5 mm or less. More preferably, the diagonal length of the fifth lens (relay lens2) may be 5.8 mm or more and 6.2 mm or less.

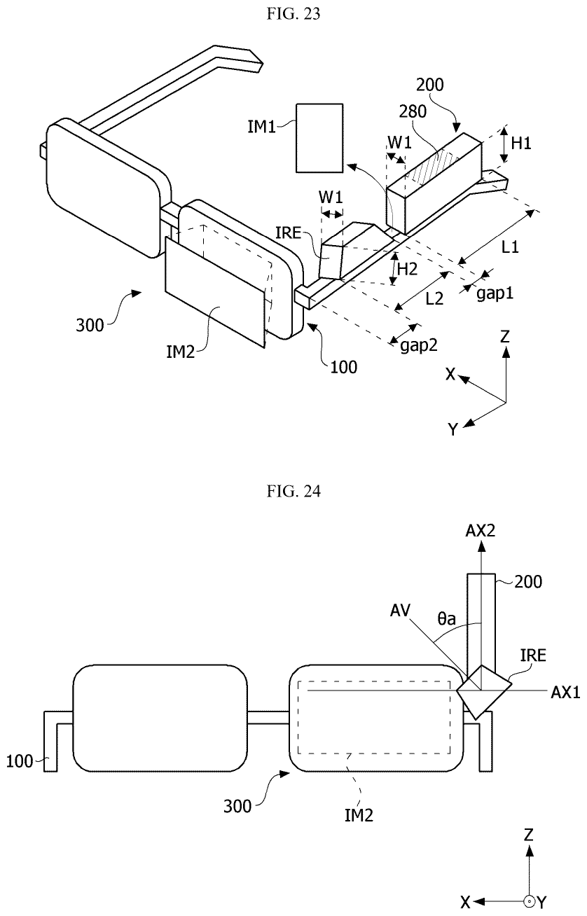

FIG. 23 is a perspective view of an electronic device according to an embodiment, and FIG. 24 is a plan view of the electronic device according to the embodiment.

Referring to FIGS. 23 and 24, the electronic device according to the embodiment of the present invention includes a frame 100, a projection device (or projector) 200, an image rotating element IRE, and a display unit (or light guide device) 300. Furthermore, the above-described content may be equally applied. Here, the projector described in the present specification may be applied to the electronic device to be described below.

The image rotating element IRE may be disposed between the projection device 200 and the light guide device 300. The image rotating element IRE may rotate light emitted from the projection device 200 about a longitudinal direction of the image rotating element IRE. That is, the image rotating element IRE may perform rotation of projection light or image emitted from the projection device 200.

First, the image rotating element IRE may be disposed adjacent to the projection device 200, and spaced apart from the projection device by a first distance gap1. For example, the image rotating element IRE may be spaced apart from the projection device 200 in a second direction (Y-axis direction). Preferably, the image rotating element IRE may be spaced apart from the projection device 200 by 16 μm to 24 μm in the second direction (Y-axis direction). That is, the first distance gap1 may be about 20 μm. Furthermore, the first distance gap1 may be in a range of 16 μm to 24 μm. With this configuration, ease of assembly may be improved, optical loss may be reduced, and degradation in the accuracy of the projected image may be inhibited.

In the present specification, the second direction (Y-axis direction) may correspond to a direction of light emission from the projection device 200. In addition, the second direction (Y-axis direction) may be a direction corresponding to a longitudinal direction or a long side of the projection device 200. That is, the projection device 200 may emit light in the second direction and may be disposed parallel to the second direction. Alternatively, the second direction may correspond to an extending direction of a side frame. In addition, a first direction (X-axis direction) may correspond to a width direction. In addition, the first direction (X-axis direction) may be parallel to a direction from the left eye to the right eye in a glasses-type electronic device. In addition, the first direction (X-axis direction) may be a direction perpendicular to the second direction. In addition, the projection device 200 may emit projection light from a side surface that has a plane formed by the first direction and the second direction. A third direction (Z-axis direction) may be a direction perpendicular to the first direction and the second direction. The third direction (Z-axis direction) may correspond to a thickness direction.

In addition, the image rotating element IRE may be disposed apart from the light guide device 300 by a second distance gap2. For example, the image rotating element IRE may be disposed apart from the light guide device 300 by the second distance gap2 in the second direction (Y-axis direction). In addition, the second distance gap2 may be 7 μm or more. Thus, the ease of assembly of the light guide device may be improved.

The projection device 200 according to the embodiment may have a predetermined field of view (FOV). The field of view (FOV) may also be referred to as an angle of view. The field of view or the like may vary depending on the size or the like of components in the light guide device. For example, the field of view may be about 30°. Preferably, the field of view may be in a range of 20° to 40°. With this configuration, the size of the projection device in the electronic device may be easily reduced.

Further, a traveling direction of light (or projection light) emitted from the projection device 200 may be parallel to the second direction (Y-axis direction). Furthermore, the traveling direction of the light (or projection light) emitted from the projection device 200 may be parallel to the longitudinal direction or long side direction of the image rotating element TRE.

Furthermore, the projection device 200 may have a length L1 and a height H1 that are different from its width W1. In the embodiment, the length L1 and the height H1 of the projection device 200 may each be greater than the width W1. In the projection device 200, a light modulator may have a length greater than its width. A diagonal length of the light modulator may be about 0.16 inches. With this configuration, a first image IM1, which is a cross section of light or projection light emitted from the projection device 200, may also have different horizontal and vertical lengths. In the image, the horizontal length may refer to a width, and the vertical length may refer to a height. In the first image IM1, a long side may correspond to the height, and a short side may correspond to the width.

In addition, the image rotating element IRE may have a length L2 and a height H2 that are different from its a width W2. In the embodiment, the length L2 and the height H2 of the image rotating element IRE may each be smaller than the width W2. For example, the length of the image rotating element IRE may be 7 mm. In addition, the width of the image rotating element IRE may be 3.2 mm. The length may be changed within a range of approximately ±20% of the above-described value, thereby enabling miniaturization and compatibility.

The projection device 200, the image rotating element IRE, and the light guide device 300 may overlap each other in the longitudinal direction or the second direction (Y-axis direction).

Accordingly, light projected from the projection device 200 may be rotated by the image rotating element IRE and provided to the light guide device 300 in the rotated state. In addition, the light guided by the light guide device 300 may be finally delivered to a user or the like. At this time, an image, which is a cross section of the light provided to the user, may be an image with a greater horizontal length than a vertical length.

In addition, by positioning the projection device 200 on an upper portion (or a lower portion) rather than on a side portion of the frame, it is possible to suppress an increase in a width of the electronic device. Furthermore, by configuring the projection device 200 to have a height similar to or smaller than that of the light guide device, miniaturization of the electronic device can be implemented. In addition, although the projection device 200 is located on the frame of the above-described electronic device, the image rotating element IRE may rotate the light (projection light) emitted from the projection device 200 such that a longer side of the image, either horizontal or vertical, corresponds to a longer side of the light guide device. That is, the image rotating element IRE may adjust the horizontal and vertical ratio of the light (image or video) emitted from the projection device so that an image or video with an appropriate horizontal and vertical ratio can be provided to the user through the light guide device. For example, the image rotating element IRE may rotate the light emitted from the projection device such that a horizontal length becomes a long side. With this configuration, when the light emitted from the projection device 200 passes through the image rotating element IRE, a second image IM2, which is a cross section of the emitted light, may have a different horizontal and vertical ratio from the first image IM1. For example, even when a vertical length is greater than a horizontal length in the first image IM1, the horizontal length may be greater than the vertical length in the second image IM2.

The image rotating element IRE may have a trapezoidal cross-section parallel to the longitudinal direction or the second direction (Y-axis direction). In addition, the image rotating element IRE may have a rectangular cross-section perpendicular to the longitudinal direction (Y-axis direction). In addition, the image rotating element IRE may be a prism. For example, the image rotating element IRE may include a dove prism.

Further, optical stops of the projection device 200 and the image rotating element IRE may be located at a first diffraction element area, which serves as an incoupler of the light guide device 300 and will be described below. Thus, miniaturization of the electronic device and improvement in optical performance may be achieved.

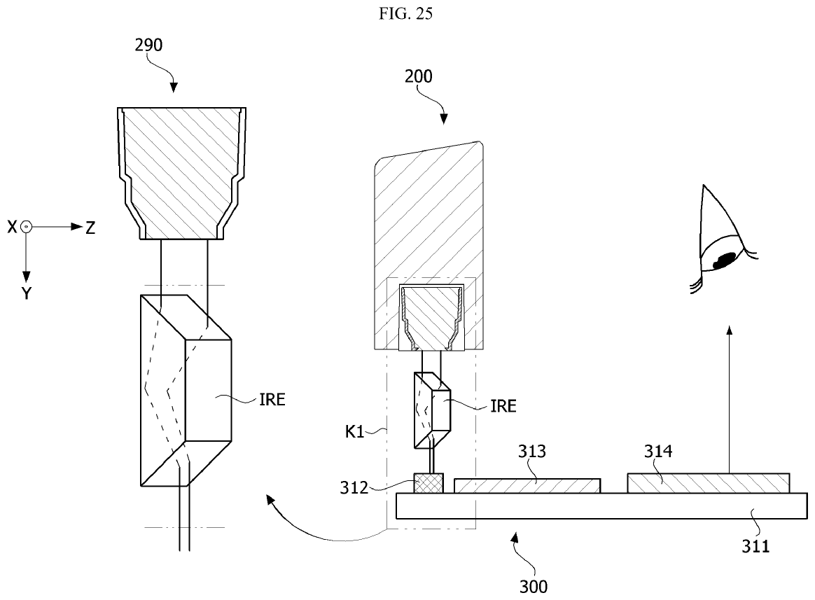

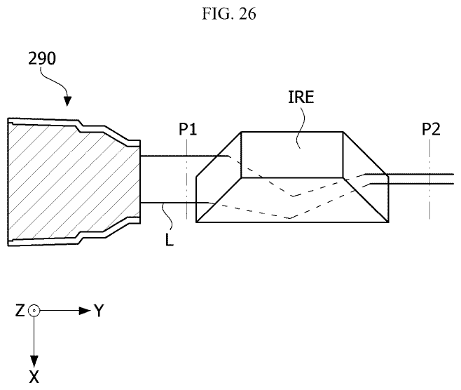

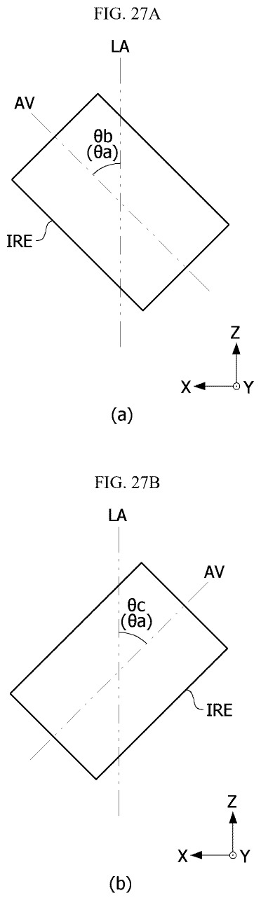

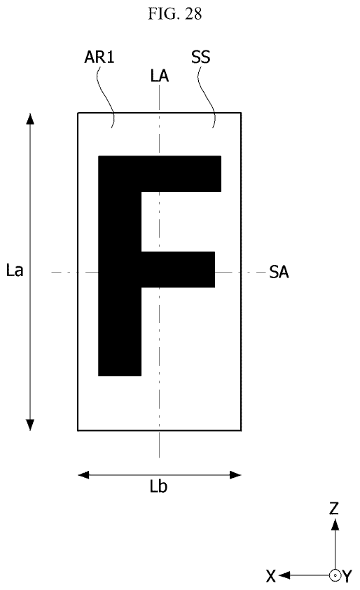

FIG. 25 is a side view of the image rotating element, the light guide device, and the projection device in the electronic device according to the embodiment, FIG. 26 is a plan view of the image rotating element and the projection device in the electronic device according to the embodiment, FIGS. 27A and 27B are front views of the image rotating element in the electronic device according to the embodiment, FIG. 28 is a schematic cross-sectional view of projection light at position P1 in FIGS. 25 and 26, and FIGS. 29 and 30 are schematic cross-sectional views of the projection light at position P2 in FIGS. 25 and 26.

Referring to FIGS. 25 and 26, in the present embodiment, the light guide device 300 may or may not include the projection device 200. For example, the light guide device 300 may include the projection device 200, a substrate, and a diffraction element (a diffraction element area). Alternatively, the light guide device 300 may include the substrate and the diffraction element (diffraction element area).

The light guide device 300 according to the embodiment may include a substrate 311 and a diffraction element unit (312, 313, and 314). As described above, the light guide device 300 may be a structure separated from the projector 200. In this case, the projector 200 and the light guide device 300 are spaced apart from each other, and the rearmost lens of the projection device or projector 200 described below and the light guide device 300 may be disposed apart from each other. In addition, as described above, the projection device or projector 200 may include a projection lens unit 290 including a plurality of lenses and a barrel.

In addition, the diffraction element unit according to the embodiment may include a plurality of diffraction element area. The diffraction element unit may be disposed on the substrate 311 and may have a nano-scale pattern. Through this, the diffraction element unit may diffract and guide light incident from the projection device or projector 200. For example, the diffraction element unit may include a first diffraction element area 312 and a second diffraction element area 314. Furthermore, the diffraction element unit may include a third diffraction element area 313 located between the first diffraction element area 312 and the second diffraction element area 314. The first diffraction element area 312 may correspond to an “in-coupler.” The second diffraction element area 314 may correspond to an “out-coupler.” The third diffraction element area 313 may correspond to a folding grating.

The light guide device 300 may change a path of light that is output from a light output unit and incident thereon, and may output the light again to the outside. The light may be sequentially incident on the first diffraction element area 312, the third diffraction element area 313, and the second diffraction element area 314, and may be output to the outside again. A direction of incidence of light on the light guide device 300 may correspond to the second direction. The second direction (Y-axis direction) may refer to a direction in which light is incident or an opposite direction thereof.

In the embodiment, the substrate 311 may guide light emitted from the projection device or projector 200. The substrate 311 may serve as a path for transmitting the light. The first diffraction element area 312, the third diffraction element area 313, and the second diffraction element area 314 may be disposed on the substrate 311. Light may undergo total internal reflection inside the substrate 311 and travel along the interior of the substrate. The substrate 311 may include a waveguide. The first diffraction element area 312, the second diffraction element area 314, and the third diffraction element area 313 may be disposed apart from each other on the substrate 311. The substrate 311 may extend in the first direction, which is perpendicular to the second direction in which light is incident. A refractive index of the substrate 311 may be in a range of 1.4 to 2.0.

The first diffraction element area 312 may guide light to be incident on the substrate 311. That is, the first diffraction element area 312 may serve as a guide for light. Alternatively, the first diffraction element area 312 may receive light. The first diffraction element area 312 may serve to guide light to be incident on the substrate 311. The first diffraction element area 312 may be disposed on the substrate 311. Light may be incident on the light guide device 300 through the first diffraction element area 312 from the outside or from the projection device or projector 200, and may be delivered along the substrate 311 to the second diffraction element area 314 and the third diffraction element area 313. The first diffraction element area 312 may change the path of light by diffracting the light.

The third diffraction element area 313 may serve to change the path of light. The third diffraction element area 313 may be disposed on the substrate 311. The third diffraction element area 313 may change the path of light that is incident through the first diffraction element area 312. By changing the path of light, the third diffraction element area 313 may guide the light toward the second diffraction element area 314. The third diffraction element area 313 may change the path of light by diffracting the light.

The second diffraction element area 314 may serve to guide light to be emitted to the outside of a user or the like. The second diffraction element area 314 may be disposed on the substrate 311. The light may be emitted to the outside of a light guide device 300 through the second diffraction element area 314. The second diffraction element area 314 may receive the light whose path has been changed by a third diffraction element area 313 and emit the light to the outside. The second diffraction element area 314 may change the path of light and emit the light to the outside. The second diffraction element area may change the path of light by diffracting the light. The second diffraction element area 314 may be disposed apart from the first diffraction element area 312. In addition, the second diffraction element area 314 may emit light.

The first diffraction element area 312, the third diffraction element area 313, and the second diffraction element area 314 may include a plurality of protrusions. The plurality of protrusions may have a uniform width, pitch, and height, and may be disposed on the first diffraction element area 312, the third diffraction element area 313, and the second diffraction element area 314. The plurality of protrusions may protrude in the first direction on the first diffraction element area 312, the third diffraction element area 313, and the second diffraction element area 314. The plurality of protrusions may be disposed apart from each other in a vector direction of a pattern including the protrusions. Depending on the width, pitch, and height of the protrusions, paths of light passing through the first diffraction element area 312, the third diffraction element area 313, and the second diffraction element area 314 may be changed differently. The width of each protrusion may refer to a width measured in the vector direction of the pattern including the protrusions. The pitch of the protrusions may refer to a distance in the vector direction of the pattern including the protrusions between one side surface of the protrusion and the same side surface of the adjacent protrusion. The height of the protrusion may refer to a height of the part protruding in the first direction. These protrusions may be disposed to have a predetermined pattern.

In the embodiment, the first diffraction element area 312, the third diffraction element area 313, and the second diffraction element area 314 may be formed of the same material or different materials. For example, the first diffraction element area 312, the third diffraction element area 313, and the second diffraction element area 314 may be formed of the same material. In addition, a refractive index of each of the first diffraction element area 312, the third diffraction element area 313, and the second diffraction element area 314 may be in a range of 1.7 to 2.7.

Furthermore, an outline (boundary area) of the first diffraction element area 312 and an outline (boundary area) of the third diffraction element area 313 may not overlap each other. When the outline (boundary area) of the first diffraction element area 312 and the outline (boundary area) of the third diffraction element area 313 overlap each other, a portion of the light incident from the third diffraction element area 313 to the second diffraction element area 314 may be blocked, and as a result, no image may be emitted from the corresponding area of the second diffraction element area 314. When the outline (boundary area) of the first diffraction element area 312 and the outline (boundary area) of the third diffraction element area 313 overlap each other, efficiency decreases, and thus, it is preferable that the outline (boundary area) of the first diffraction element area 312 and the outline (boundary area) of the third diffraction element area 313 do not overlap each other.

Although the projection device or projector 200 and the IRE are illustrated as being disposed in a straight line in FIG. 25, the IRE may be inclined at a predetermined angle with respect to the projector 200 in order to adjust the proportion of light projected by the projector 200.

Referring further to FIGS. 27A to 29, as described above, the image rotating element IRE may change the angle and proportion of light emitted from the projection device 200.

More specifically, the image rotating element IRE may rotate an image SS, which is a cross section of the projection light projected from the projection device 200. For example, the image SS of the light incident on the image rotating element IRE may correspond to the first image described above.

At a first position P1 in FIGS. 25 and 26, the image, which is a cross section of the projection light, may have a major axis LA and a minor axis SA, as shown in FIG. 28. For example, the major axis LA may be an axis parallel to the Z-axis, and the minor axis SA may be an axis parallel to the X-axis. Here, the axes parallel to the major and minor axes are described based on FIG. 28, and the axes parallel to the major and minor axes may change depending on the rotation of the image. In addition, the projection light emitted from the projection device 200 may form an image in which a vertical length is greater than a horizontal length.

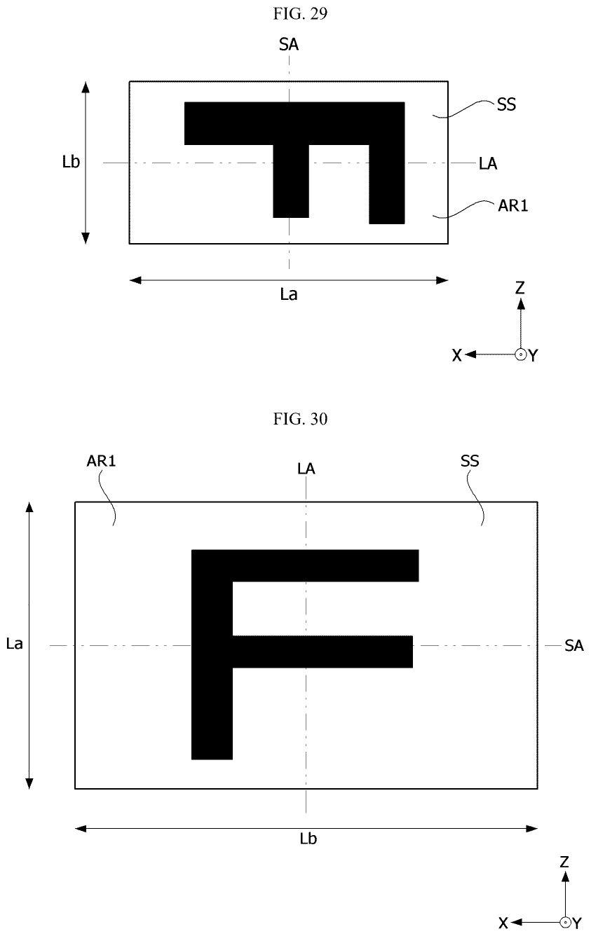

The image SS, which is a cross section of the projection light that has passed through the image rotating element IRE, may be rotated at a second position P2 in FIGS. 25 and 26, as shown in FIG. 29. That is, based on the image, which is a cross section of the projection light, the image at the first position P1 and the image at the second position P2 are different from each other. Furthermore, the image at the second position P2 may be rotated by a predetermined angle compared to that at the first position P1. As such, compared to FIG. 28, the projection light passing through the image rotating element IRE may be rotated 90° about its traveling direction (e.g., the second direction (Y-axis direction)), as shown in FIG. 29. As shown in FIG. 30 compared to FIG. 28, the projection light passing through the image rotating element IRE may not be rotated by a predetermined angle, but a ratio of a vertical length La to a horizontal length Lb of the image at the second position P2 may be changed compared to that at the first position P1, as shown in FIG. 30. (For example, at the first position P1, the vertical length La may be greater than or equal to the horizontal length Lb, whereas at the second position P2, the vertical length La may be shorter than the horizontal length Lb. The ratio of the vertical length La to the horizontal length Lb at the second position P2 may be 3:4 or 10:12).

In addition, FIGS. 29 and 30 illustrate images that may be formed on the first diffraction element area 312 after light projected by the projector is rotated or has its ratio changed by the IRE. FIG. 30 is an image visible to a user's eye after the light projected by the projector is changed in ratio by the IRE and diffracted by the diffraction element areas 312, 313, and 314.

As described above, the image rotating element IRE may include a dove prism. Furthermore, the image rotating element TRE may have an isosceles trapezoidal cross-sectional shape parallel to the longitudinal direction.

Further, the longitudinal directions of the image rotating element TRE and the projection device 200 may be parallel to the traveling direction of the projection light (e.g., the second direction or the Y-axis direction). In addition, as shown in FIGS. 27A and 27B, the image rotating element IRE may be disposed such that a vertical axis AV forms a first angle with the major axis LA of the projection light incident on the image rotating element IRE. At this time, as a viewing direction DEH rotates counterclockwise, the first angle may be represented as “θb” (for counterclockwise rotation) or “θc” (for clockwise rotation), as shown in FIGS. 27A and 27B. For example, the first angle θa may be 45°. In this case, to form the first angle θa, the image rotating element TRE may be rotated clockwise or counterclockwise about the second direction or the Y-axis direction with respect to the major axis LA of the projection light.

In such a structure, the projection light incident on the image rotating element IRE may be rotated twice the first angle θa about the longitudinal direction of the image rotating element IRE (the second direction) as the projection light passes through the image rotating element IRE. For example, when the first angle θa is 45°, the projection light incident on the image rotating element IRE may be rotated 90° about the longitudinal direction of the dove prism. Furthermore, the projection light may be vertically inverted while passing through the image rotating element IRE.

More specifically, as shown in FIG. 28, an upper-left area of the image SS, which is a cross section of the projection light at the first position P1, may be a first area AR1. In this case, as the projection light at the first position P1 shown in FIG. 28 passes through the image rotating element IRE, the image may be rotated 90° about the traveling direction of the projection light (e.g., the second direction or the Y-axis direction). Accordingly, as shown in FIG. 29, the first area AR1 may move to a lower right side (or a lower left side) as in the image SS which is a cross section of the projection light at the second position P2. As such, the shape of the image SS, which is a cross section of the projection light, may be rotated 90° while passing through the image rotating element IRE.

Furthermore, an additional lens may be further disposed at the rear end of the image rotating element TRE to adjust the size of the image, which is a cross section of the projection light.

Furthermore, according to the embodiment, as an angle formed between the length and height of the projection device 200 increases, an angle (i.e., the above-described first angle) formed by the length and height of the image rotating element IRE may also increase. Table 10 below shows the first angle of the image rotating element corresponding to the angle of the projection device according to the embodiment.

TABLE 10

| Angle of projection device (DLP) | First angle of image rotating element (θa in FIG. 24) | |
|---|---|---|
| Deg | Deg (counterclockwise) | Deg (clockwise) |
| 0 | −45 | 45 |
| 5 | −37.5 | 47.5 |
| 10 | −30 | 50 |
| 15 | −22.5 | 52.5 |
| 20 | −15 | 55 |
| 25 | −7.5 | 57.5 |
| 30 | 0 | 60 |
| 35 | 7.5 | 62.5 |
| 40 | 15 | 65 |
| 45 | 22.5 | 67.5 |
| 50 | 30 | 70 |
| 55 | 37.5 | 72.5 |
| 60 | 45 | 75 |
| 65 | 52.5 | 77.5 |
| 70 | 60 | 80 |
| 75 | 67.5 | 82.5 |
| 80 | 75 | 85 |
| 85 | 82.5 | 87.5 |
| 90 | −90 | 90 |

Here, the angle of the projection device (DLP) may refer to an angle (an angle less than or equal to 90°) formed between the projection device and a plane perpendicular to the second axis AX2 or the first axis AX1, as shown in FIG. 24. For example, in FIGS. 23 and 24, an angle of the projection device may be 0°. In addition, the first axis AX1 may be parallel to an axis extending from the left eye to the right eye, or in the opposite direction. In addition, the first axis AX1 may correspond to a width direction of the projection device. The second axis AX2 is in a direction perpendicular to the first axis AX1 and may correspond to a height direction of the projection device 200. Furthermore, both the first axis AX1 and the second axis AX2 may be directions perpendicular to the longitudinal direction or the light emission direction. Accordingly, the first axis AX1 may be perpendicular to the direction of light emission from the projection device. In addition, the second axis AX2 may be perpendicular to the direction of light emission from the projection device. Referring to FIGS. 24, 25, Table 1, and the like an angle formed by the height H1 of the projection device or projector 200 according to the embodiment and a cross section perpendicular to the first axis may be different from an angle formed between the height H2 of the image rotating element IRE and a cross section perpendicular to the first axis. For example, when the angle formed between the height H1 of the projection device or projector 200 and the cross section perpendicular to the first axis (corresponding to the angle of the projection device) is 0°, the angle formed between the height H2 of the image rotating element IRE and the cross section perpendicular to the first axis (corresponding to the first angle) may be 45°.

Furthermore, the size of the image rotating element IRE may vary depending on the angle formed between the height H1 of the projection device or projector 200 and the cross section perpendicular to the first axis (corresponding to the angle of the projection device). For example, as the angle formed between the height H1 of the projection device or projector 200 and the cross section perpendicular to the first axis increases, the size of the image rotating element IRE may increase. When the angle (corresponding to the angle of the projection device) formed by the height H1 of the projection device or projector 200 and the cross section perpendicular to the first axis is 30°, the size of the image rotating element IRE may be 3.2*3.2*7 (height*width*length), and this size may vary within a range of 10%. In this case, when the angle (corresponding to the angle of the projection device) formed by the height H1 of the projection device or projector 200 and the cross section perpendicular to the first axis increases to 50°, the size of the image rotating element IRE may increase to 5.3*5.3*11.7 (height*width*length), and this size may also vary within a range of ±10%.

Features, structures, effects, and the like described in the above embodiments are included in at least one embodiment, and are not necessarily limited to only one embodiment. Furthermore, features, structures, effects, and the like illustrated in each embodiment can be combined or modified for other embodiments by those of ordinary skill in the art to which the embodiments belong. Accordingly, the contents related to such combinations and modifications should be interpreted as being included in the scope of the embodiments.

Although the embodiments have been described above, the embodiments are merely examples and not intended to limit the present invention and it may be seen that a variety of modifications and applications not described above may be made by one of ordinary skill in the art without departing from the essential features of the embodiments. For example, each component specifically shown in the embodiment may be implemented with modifications. In addition, it should be construed that differences related to such changes and applications are included in the scope of the embodiments defined in the appended claims.

1. An electronic device comprising:
a projector;
a light guide device configured to guide light emitted from the projector; and
an image rotating element disposed between the projector and the light guide device,
wherein the image rotating element has a trapezoidal cross-section parallel to a longitudinal direction thereof and rotates the light emitted from the projector about the longitudinal direction of the image rotating element.

2. The electronic device of claim 1, wherein the image rotating element is disposed adjacent to the projector and is spaced apart from the projector by a first distance.

3. The electronic device of claim 1, wherein the image rotating element is disposed spaced apart from the light guide device by a second distance.

4. The electronic device of claim 1, wherein a traveling direction of the light emitted from the projector is parallel to the longitudinal direction of the image rotating element.

5. The electronic device of claim 1, wherein when an angle formed between a length and a height of the projector increases, an angle formed between a length and a height of the image rotating element increases.

6. The electronic device of claim 1, wherein an angle formed between a height of the projector and a cross section perpendicular to a first axis is different from an angle formed between a height of the image rotating element and the cross section perpendicular to the first axis.

7. The electronic device of claim 1, wherein when an angle formed between a height of the projector and a cross section perpendicular to a first axis is 0°, an angle formed between a height of the image rotating element and the cross section perpendicular to the first axis is 45°.

8. The electronic device of claim 1, wherein optical stops of the projector and the image rotating element are located at an incoupler of the light guide device.

9. The electronic device of claim 1, wherein a width of the image rotating element is smaller than a length thereof.

10. The electronic device of claim 1, wherein the projector, the image rotating element, and the light guide device overlap each other in the longitudinal direction.

11. The electronic device of claim 1,
comprising a frame on which the projector and the image rotating element are seated.

12. The electronic device of claim 1,
wherein the image rotating element includes a prism having a rectangular cross-section perpendicular to the longitudinal direction.

13. The electronic device of claim 1,
wherein the projector has a length and a height greater than a width.

14. The electronic device of claim 1,
wherein the image rotating element is configured to change an angle and a proportion of light emitted from the projector.

15. The electronic device of claim 1,
wherein the image rotating element is disposed such that a vertical axis of the image rotating element forms a first angle with a major axis of projection light incident on the image rotating element.

16. The electronic device of claim 1,
wherein the image rotating element is rotated clockwise or counterclockwise about the longitudinal direction with respect to the major axis of projection light to form a first angle.

17. The electronic device of claim 1,
wherein a size of the image rotating element changes corresponding to an angle formed between a height of the projector and a cross section perpendicular to a first axis.

18. The electronic device of claim 1,
wherein the length and height of the image rotating element are different from a width thereof.

19. The electronic device of claim 1,
wherein a light modulator of the projector has a length greater than a width.

20. The electronic device of claim 1,
comprising a lens disposed at a rear end of the image rotating element.
